(19) United States
(12) Patent Application Publication
(10) Pub. No.: US 2004/0090714 A1
(43) Pub. Date: May 13, 2004

(54) Rotating head device including magnetic head comprising at least two magnetic reproducing elements, and magnetic recording/reproducing apparatus using the same

(75) Inventor: Katsuya Kikuiri, Niigata-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/702,862

(22) Filed: Nov. 6, 2003

(30) Foreign Application Priority Data
Nov. 13, 2002 (JP) 2002-329823

(51) Int. Cl. G11B 5/52

(52) U.S. Cl. 360/271.5

(57) ABSTRACT

A magnetic recording/reproducing apparatus includes first magnetic heads including at least two magnetic reproducing elements disposed at a first azimuth angle, and second magnetic heads including at least two magnetic reproducing elements disposed at a second azimuth angle. The first and second magnetic heads are mounted to a rotating drum. The magnetic reproducing elements of the magnetic heads scan at the same time recording tracks formed by recording signals at the same azimuth angle, with an odd number of at least three recording tracks being disposed between the recording tracks that are scanned.

### BACKGROUND OF THE INVENTION

1. Field of the Invention

The present invention relates to a rotating head device including a magnetic head and to a magnetic recording/reproducing apparatus using the rotating head device. More particularly, the present invention relates to a rotating head device including a magnetic head comprising at least two magnetic reproducing elements and to a magnetic recording/reproducing apparatus using the rotating head device.

2. Description of the Related Art

In, for example, a magnetic recording/reproducing apparatus of a video system and a magnetic recording/reproducing apparatus for storing computer data, a magnetic head is mounted to a rotating drum of a rotating head device, a magnetic tape comes into contact with the rotating drum and is transported in a helical path, and the rotating drum rotates to perform a recording operation and a reproducing operation on the magnetic tape by a helical scanning method.

FIG. 19 is a plan view of a rotating head device that is disposed in a magnetic recording/reproducing apparatus, with magnetic heads being installed in the rotating head device. FIG. 20 is a partial enlarged view of a state in which a magnetic tape is in contact with the rotating head device shown in FIG. 19. FIG. 21 is a perspective view of an example of a magnetic head that is installed in the rotating head device. FIG. 22 is a plan view of the magnetic head shown in FIG. 21 as seen from its surface opposing the magnetic tape (as seen from a direction Y2 in FIG. 21). FIG. 23 is a plan view of another magnetic head that is installed in the rotating head device as seen from its surface opposing the magnetic tape. FIG. 24 is a plan view of a recording surface of the magnetic tape as seen from a rotating drum.

In a rotating head device 1 shown in FIG. 19, a stationary drum (not shown) is fixed, and a rotating drum 1a, which is formed coaxially with the stationary drum, is rotatably supported at the stationary drum. By power of a motor (not shown), the rotating drum 1a is rotationally driven in a direction of an arrow marked beside the rotating drum 1a.

A supply reel hub 31, used to supply a magnetic tape T, and a take-up reel hub 32 are rotatably installed in the magnetic recording/reproducing apparatus. The magnetic tape T is wound upon both reel hubs 31 and 32.

The magnetic tape T is led out by loading posts 33, and wound upon the rotating head device 1.

When performing a reproducing operation on the magnetic tape T, the magnetic tape T is press-contacted with a capstan 35 by a pinch roller 34, and is transported at a constant velocity V based on the rotating velocity of the capstan 35.

The magnetic tape T, which is a recording medium, is wound upon the rotating head device 1 at a predetermined angle in a helical path, and is transported in a direction of an arrow marked beside the magnetic tape T. During this time, the rotating drum 1a rotates, and magnetic heads H1 and H2, which are mounted to the rotating drum 1a, scan the magnetic tape T. In the rotating head device 1 shown in FIG. 19, the magnetic heads H1 and H2, used for a reproducing operation, are disposed opposite each other.

As shown in FIG. 21, the magnetic head H1 is formed as follows. A reproduction magneto-resistive (MR) thin-film magnetic head 3 and an insulating layer 4 (protective layer) are formed on a base 2 (formed of alumina titanium carbide) by a thin-film formation process. Then, a protective base 5 (formed of alumina titanium carbide) is adhered to the insulating layer 4 using adhering means (not shown), such as an epoxy adhesive.

A magnetic gap 6 of the MR thin-film magnetic head 3 appears at a magnetic-tape-opposing surface H1A of the magnetic head H1. Electrical current that flows to the MR thin-film magnetic head 3 is supplied thereto through electrodes 7.

With the magnetic head H1 being mounted to the rotating drum 1a, the magnetic head H1 is in contact the magnetic tape T as shown in FIG. 20. Here, as shown in FIG. 20, a direction a corresponds to a direction of rotation of the rotating drum 1a, and a direction β corresponds to a vertical direction, which is a direction of sliding of the magnetic tape T.

The magnetic head H1 is formed with a convex arc shape having a curvature radius R along the vertical direction, and having a curvature radius r along a horizontal direction that is perpendicular to the vertical direction.

The recording/reproducing apparatus makes use of what is called a helical scan method. Therefore, as shown in FIG. 22, a first azimuth angle θ1 is formed at the magnetic gap 6 of the MR magnetic head 3 of the magnetic head H1 with respect to a vertical line V in the direction of rotation of the rotating drum 1a (that is, a scanning direction of a magnetic reproducing element with respect to the magnetic tape T) and in accordance with the helical path.

In other words, as shown in FIG. 22, in the magnetic head H1, the first azimuth angle θ1 is formed at the magnetic gap 6 of the MR magnetic head 3 by a line that inclines in one direction from the vertical line V in the direction of rotation.

A right edge 8 and a left edge 9 of the tape-opposing surface H1A are also tilted at an angle θ1, which is equal to the azimuth angle at the magnetic gap 6. An acute angled portion 12, formed by intersection of the right edge 8 and an upper edge 10, is disposed more outward in the vertical direction than an angled portion 13, formed by intersection of the right edge 8 and a lower edge 11. An angled portion 14, formed by intersection of the left edge 9 and the upper edge 10, is disposed more inward in the vertical direction than an acute angled portion 15, formed by intersection of the left edge 9 and the lower edge 11. Therefore, the tape-opposing surface H1A in plan view and as seen from the magnetic tape has the shape of a parallelogram, as shown in FIG. 22.

The magnetic head H2 has almost the same structure as the magnetic head H1, and is mounted to the rotating drum 1a. As shown in FIG. 23, however, a second azimuth angle θ2 is formed at a magnetic gap 16 of an MR thin-film magnetic head 43 of the magnetic head H2. The second azimuth angle θ2 is formed by a line that inclines in a direction opposite to the direction in which the line that forms the first azimuth angle θ1 in the first magnetic head H1 inclines. The absolute positions where the angles θ1 and θ2 are formed are generally equal to each other. A right edge 18 and a left edge 19 of a tape-opposing surface H2A of the magnetic head H2 are tilted at an angle θ2, which is equal to the second azimuth angle of the magnetic gap 16. An acute angled portion 23, formed by intersection of the right edge 18 and a lower edge 21, is disposed more outward in the vertical direction than an angled portion 22, formed by intersection of the right edge 18 and an upper edge 20. An angled portion 25, formed by intersection of the left edge 19 and the lower edge 21, is disposed more inward in the vertical direction than an acute angled portion 24, formed by intersection of the left edge 19 and the upper edge 20. Therefore, as shown in FIG. 23, the tape-opposing surface H1A in plan view and as seen from the magnetic tape has the shape of a parallelogram whose vertical sides are tilted in a direction opposite to the direction in which the vertical sides are tilted in the magnetic head H1.

As shown in FIG. 24, two types of recording tracks, that is, tracks R (R1, R2, R3, etc.) having signals recorded at the first azimuth angle θ1 and tracks L (L1, L2, L3, etc.) having signals recorded at the second azimuth angle θ2 are formed on the magnetic tape T. A frame F1 is formed by two tracks, the tracks R1 and L1. In the same way, a frame F2 is formed by two tracks, the tracks R2 and L2. By the frames F1 and F2, for example, one image plane is formed between vertical synchronizing signals.

As shown in FIG. 24, when the magnetic heads H1 and H2 scan the magnetic tape T having the tracks R and tracks L formed thereon, the MR thin-film magnetic head 3 of the magnetic head H1 scans a track R and reads a recording signal on the track. On the other hand, the MR thin-film magnetic head 43 of the magnetic head H2 scans a track L and reads a recording signal on the track.

In such a rotating head device 1, in order to read a signal recorded on the magnetic tape T and increase the transport speed of the magnetic tape T, that is, in order to increase what is called the transfer rate, the number of magnetic heads that are mounted to the rotating drum 1a is increased.

Disposing a plurality of MR thin-film magnetic heads in one magnetic head has been proposed. In this case, when MR thin-film magnetic heads are disposed at a predetermined interval in the sliding direction of the magnetic tape, or electrodes that are disposed at respective ends of the MR thin-film magnetic heads are used in common with those disposed at respective ends of adjacent MR thin-film magnetic heads, the distance between the MR thin-film magnetic heads in a direction perpendicular to the sliding direction of the magnetic tape (that is, in a recording track width direction of the magnetic tape) is reduced, so that high recording density can be achieved.

Such a magnetic head is disclosed in, for example, Japanese Unexamined Patent Application Publication Nos. 2001-184610 (Patent Document 1), 10-334417 (Patent Document 2), and 11-175926 (Patent Document 3).

However, increasing the number of magnetic heads that are mounted to the rotating drum increases costs. Since, in recent years, tracks are becoming narrower due to an increase in recording density, it is becoming difficult to adjust the scanning position of an MR thin-film magnetic head to the position of a recording track of the magnetic tape. When the number of magnetic heads increases, it becomes more difficult to adjust the scanning position of an MR thin-film magnetic head to a recording track.

In one magnetic head having a plurality of MR thin-film magnetic heads disposed at a predetermined interval in the sliding direction of the magnetic tape, each MR thin-film magnetic head requires an electrode. Therefore, there is a limit as to how narrow tracks can be made with an increase in recording density in the future.

Even for a magnetic head in which electrodes of adjacent MR thin-film magnetic heads are used in common in order to reduce the distance between the MR thin-film magnetic heads, there is a limit as to how narrow tracks can be made. In other words, in order to narrow tracks with an increase in recording density, it is necessary to make the distance between the MR thin-film magnetic heads in a direction perpendicular to the sliding direction of the magnetic tape (that is, the recording track width direction of the magnetic tape) very small. However, hard bias layers, which are disposed at respective end portions of the MR thin-film magnetic heads, are considerably larger than the MR thin-film magnetic heads. Therefore, there is a limit as to how small the distance between the MR thin-film magnetic heads adjacent to each other can be made. Consequently, tracks cannot be made narrower in the years to come.

### SUMMARY OF THE INVENTION

Accordingly, it is an object of the present invention to provide a rotating head device which can be reduced in cost and which makes it possible to increase transfer rate and to narrow tracks, and a magnetic recording/reproducing apparatus using the rotating head device.

To this end, according to one aspect of the present invention, there is provided a rotating head device comprising a rotating drum whose outer peripheral surface is a sliding surface that slides on a recording medium, and a plurality of magnetic heads, a first magnetic head and a second magnetic head, disposed at the sliding surface of the rotating drum. The first magnetic head and the second magnetic head are mounted to the rotating drum. The first magnetic head comprises at least two magnetic reproducing elements disposed at a first azimuth angle with respect to a direction of sliding on the recording medium. The second magnetic head comprises at least two magnetic reproducing elements disposed at a second azimuth angle with respect to the direction of sliding on the recording medium. The second azimuth angle is formed by a line that inclines in a direction opposite to a direction in which a line that forms the first azimuth angle inclines. The first magnetic head and the second magnetic head are positioned, so that, when the rotating drum rotates, the magnetic reproducing elements of the first magnetic head scan at the same time recording tracks formed by recording signals at the same first azimuth angle, with an odd number of at least three recording tracks being disposed between the recording tracks that are scanned by the first magnetic head, and the magnetic reproducing elements of the second magnetic head scan at the same time recording tracks formed by recording signals at the second azimuth angle that is different from the first azimuth angle, with an odd number of at least three recording tracks being disposed between the recording tracks that are scanned by the second magnetic head.

In the one aspect, a first magnetic head including at least two magnetic reproducing elements disposed at a first azimuth angle and a second magnetic head including at least two magnetic reproducing elements disposed at a second azimuth angle are both mounted to the rotating drum. In the first magnetic head, the magnetic reproducing elements scan at the same time recording tracks having at least one track disposed therebetween among a plurality of recording tracks that are formed by recording signals at the first azimuth angle, and read recording information. In the second magnetic head, the magnetic reproducing element scans at the same time recording tracks having at least one track disposed therebetween among a plurality of recording tracks formed by recording signals at the second azimuth angle, and read recording information. The first and second magnetic heads are disposed at the rotating drum so that the magnetic reproducing elements of the second magnetic head are positioned in such a manner as to scan recording tracks formed by recording signals at an azimuth angle that is different from the azimuth angle of the recording tracks scanned by the magnetic reproducing elements of the first magnetic head. In the one aspect, since the first and second magnetic heads each comprise a plurality of magnetic reproducing elements, it is possible to increase the efficiency with which the information recorded along the recording tracks is read, and to increase the transfer rate of the recording medium. In addition, since it is not necessary to increase the number of magnetic heads to increase the transfer rate, it is possible to reduce costs and to match the position of a recording track of the recording medium and a scanning position of each magnetic reproducing element. Further, since the magnetic reproducing elements of each of the first and second magnetic heads scan at the same time recording tracks having at least one track disposed therebetween among the plurality of recording tracks that are formed by recording signals at the same azimuth angle, it is possible to increase the distance between the magnetic reproducing elements in a longitudinal direction compared to the case in which recording tracks that are disposed closest to each other are scanned by the magnetic reproducing elements. Therefore, when the tracks are narrowed due to an increase in recording density, it is possible to dispose structural portions, such as hard bias layers, on respective end portions of the magnetic reproducing elements.

In a first form, after the magnetic reproducing elements of the first magnetic head have scanned the recording tracks, the magnetic reproducing elements of the second magnetic head scan recording tracks that are adjacent to the recording tracks that have been scanned by the magnetic reproducing elements of the first magnetic head.

By virtue of such a structure, when a read piece of recording information is reproduced, the information output order can be re-set.

In a second form, the first magnetic head and the second magnetic head are disposed close to each other at the rotating drum.

In a third form, the first magnetic head and the second magnetic head that are disposed close to each other are defined as a set, and two of the sets, a first set and a second set, are disposed at the rotating drum at an angle of 90 degrees from each other in a direction of rotation thereof.

In a fourth form, the first magnetic head and the second magnetic head that are disposed close to each other are defined as a set, and two of the sets, a first set and a second set, are disposed at the rotating drum at an angle of 180 degrees from each other.

In a fifth form, the first and second magnetic heads are disposed at the rotating drum at an angle of 180 degrees from each other.

In this way, in the rotating head device having a plurality of magnetic heads that are mounted to one rotating drum, it is possible to efficiently read information that is recorded on the magnetic tape.

According to another aspect of the present invention, there is provided a magnetic recording/reproducing apparatus comprising any one of the aforementioned rotary head devices, and magnetic tape feeding means for transporting a magnetic tape as a result of bringing the magnetic tape within a predetermined angle range of the sliding surface of the rotating drum.

In a first form, a recording track of the magnetic tape is not scanned again by a different magnetic reproducing element.

In a second form, after the first magnetic head of the first set has scanned the magnetic tape, the magnetic tape is transported by an amount corresponding to two tracks by the time the first magnetic head of the second set scans the magnetic tape, and, after the first magnetic head of the second set has scanned the magnetic tape, the magnetic tape is transported by an amount corresponding to six tracks by the time the first magnetic head of the first set scans the magnetic tape.

By virtue of such a structure, information that is recorded along a recording track of the magnetic tape can be read with high efficiency, and the transfer rate of the magnetic tape can be increased.

In a third form, a recording track of the magnetic tape is scanned again by a different magnetic reproducing element.

In a fourth form, from the time the first magnetic head of the first set scans the magnetic tape to the time the first magnetic head of the second set scans the magnetic tape, the magnetic tape is transported by an amount corresponding to two tracks.

By virtue of such a structure, since information that is recorded along the same recording track can be read a plurality of times, even if a reading failure occurs, it is possible to omit the re-reading operation on the recording medium.

In a fifth form, from the time the first magnetic head scans the magnetic tape to the time the second magnetic head scans the magnetic tape, the magnetic tape is transported by an amount corresponding to one track.

Even if such a structure is used, since information that is recorded along the same recording track can be read a plurality of times, even if a reading failure occurs, it is possible to omit the re-reading operation on the recording medium.

### BRIEF DESCRIPTION OF THE DRAWINGS

FIG. 1 is a plan view of a rotating head device of a first example of a first embodiment of the present invention;

FIG. 2 is a partial enlarged view of a state in which a magnetic tape is in contact with the rotating head device shown in FIG. 1;

FIG. 3 is a perspective view of an example of a magnetic head that is installed in the rotating head device shown in FIG. 1;

FIG. 4 is a plan view of the magnetic head shown in FIG. 3 as seen from its surface opposing the magnetic tape;

FIG. 5 is a perspective view of another example of a magnetic head that is installed in the rotating head device shown in FIG. 1;

FIG. 6 is a plan view of the magnetic head shown in FIG. 5 as seen from its surface opposing the magnetic tape;

FIG. 7 is a plan view showing the relationship between recording tracks of the magnetic tape and scanning by the magnetic heads that are installed in the rotating head device shown in FIG. 1;

FIG. 8 shows the relationship between rotation of a rotating drum that is installed in the rotating head device shown in FIG. 1 and scanning of the recording tracks by the magnetic heads that are mounted to the rotating drum;

FIG. 9 shows a process from head output to output of recording information read by the magnetic heads that are installed in the rotating head device shown in FIG. 1;

FIG. 10 is a plan view of a rotating head device of a second example of the first embodiment of the present invention;

FIG. 11 is a plan view showing the relationship between recording tracks of a magnetic tape and scanning by magnetic heads that are installed in the rotating head device shown in FIG. 10;

FIG. 12 shows the relationship between rotation of a rotating drum that is installed in the rotating head device shown in FIG. 10 and scanning of the recording tracks by the magnetic heads that are mounted to the rotating drum;

FIG. 13 is a plan view of a rotating head device of a second embodiment of the present invention;

FIG. 14 is a partial enlarged view of a state in which the magnetic tape is in contact with the rotating head device shown in FIG. 13;

FIG. 15 is a partial enlarged view of a state in which the magnetic tape is in contact with the rotating head device shown in FIG. 13;

FIG. 16 is a plan view showing the relationship between recording tracks of the magnetic tape and scanning by magnetic heads that are installed in the rotating head device shown in FIG. 13;

FIG. 17 shows the relationship between rotation of a rotating drum that is installed in the rotating head device shown in FIG. 13 and scanning of the recording tracks by the magnetic heads that are mounted to the rotating drum;

FIG. 18 shows a process from head output to output of recording information read by the magnetic heads that are installed in the rotating head device shown in FIG. 13;

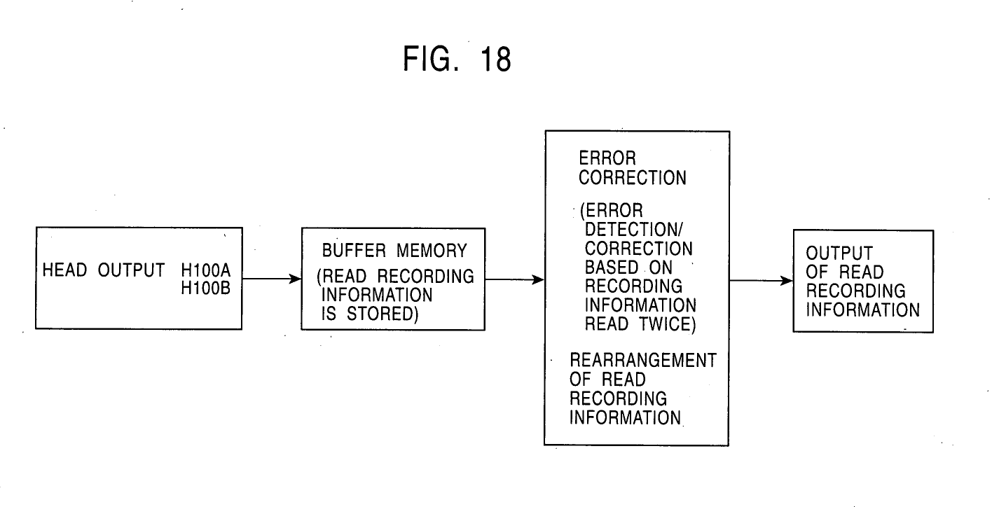

FIG. 19 is a plan view of a related rotating head device;

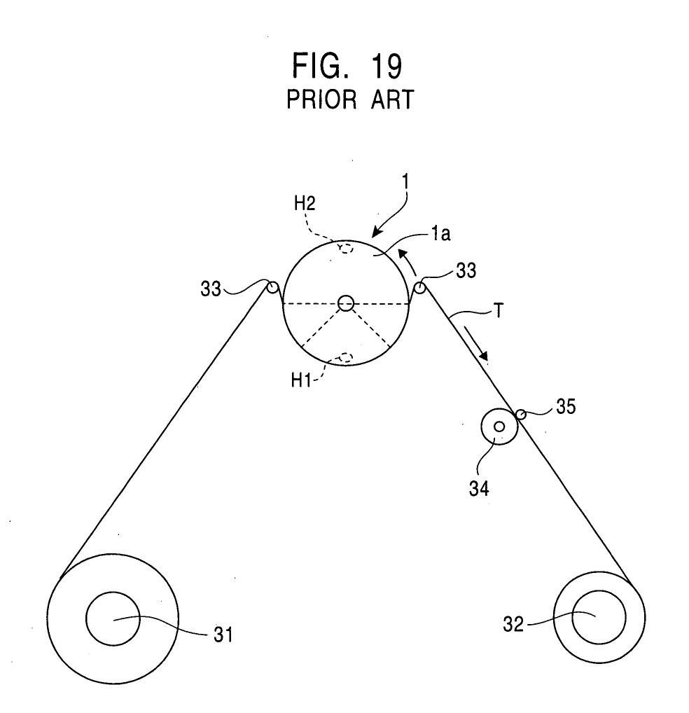

FIG. 20 is a partial enlarged view of a state in which a magnetic tape is in contact with the rotating head device shown in FIG. 19;

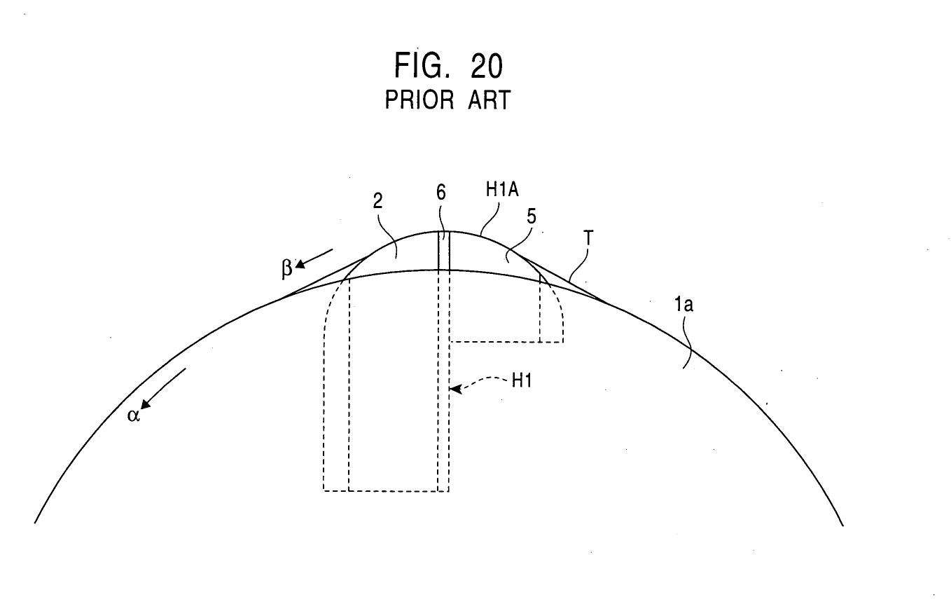

FIG. 21 is a perspective view of an example of a magnetic head that is installed in the rotating head device shown in FIG. 19;

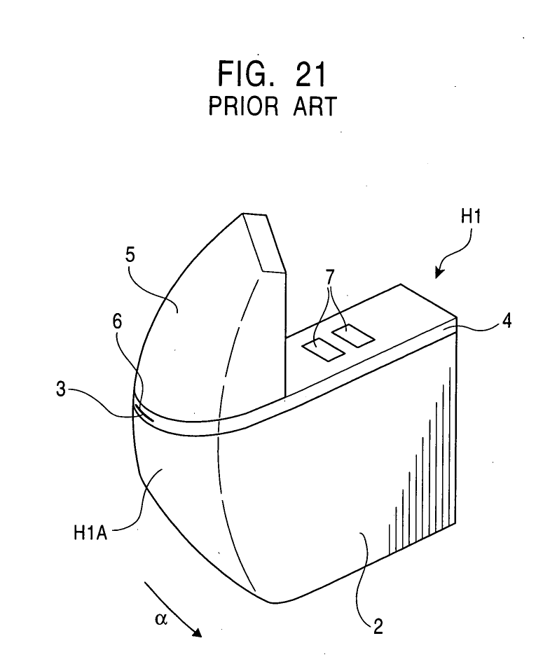

FIG. 22 is a plan view of the magnetic head shown in FIG. 21 as seen from its surface opposing the magnetic tape;

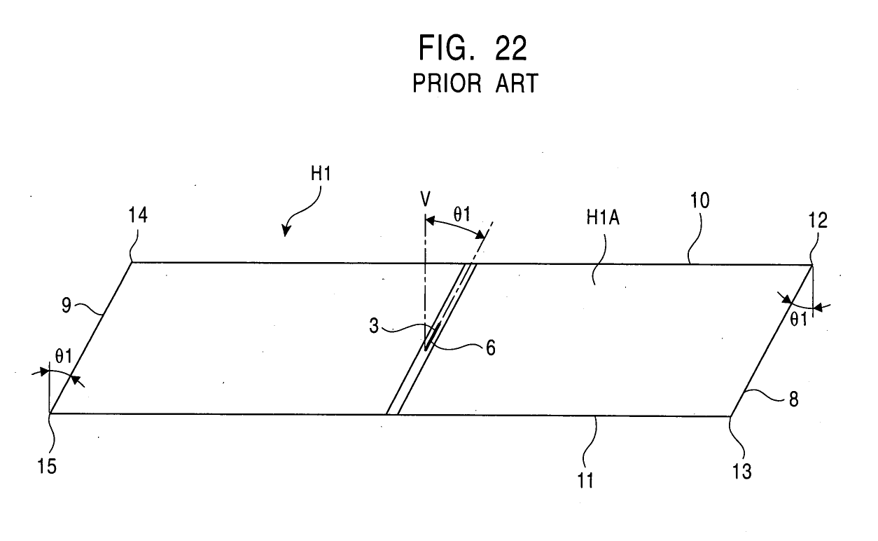

FIG. 23 is a plan view of another example of a magnetic head that is installed in the rotating head device shown in FIG. 19 as seen from its surface opposing the magnetic tape; and

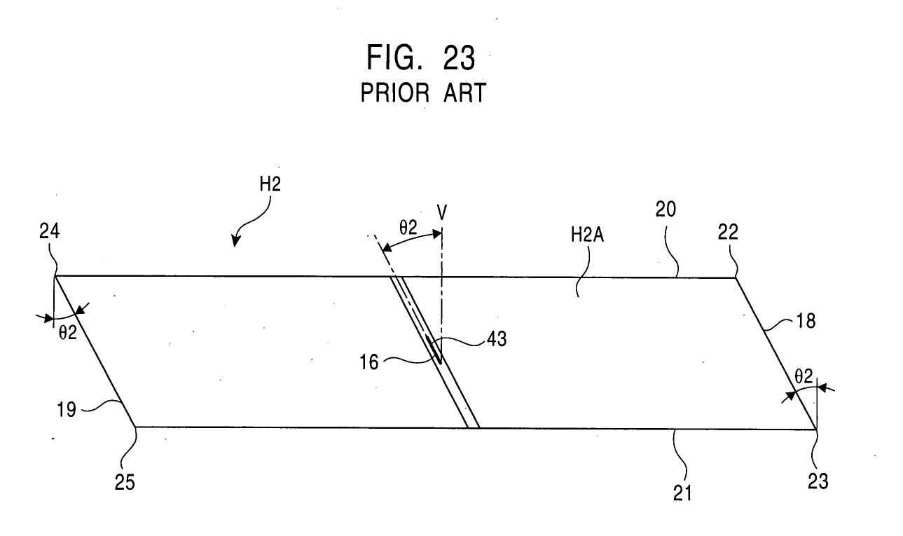

FIG. 24 is a plan view showing the relationship between recording tracks of the magnetic tape and scanning by the magnetic heads that are installed in the rotating head device shown in FIG. 19.

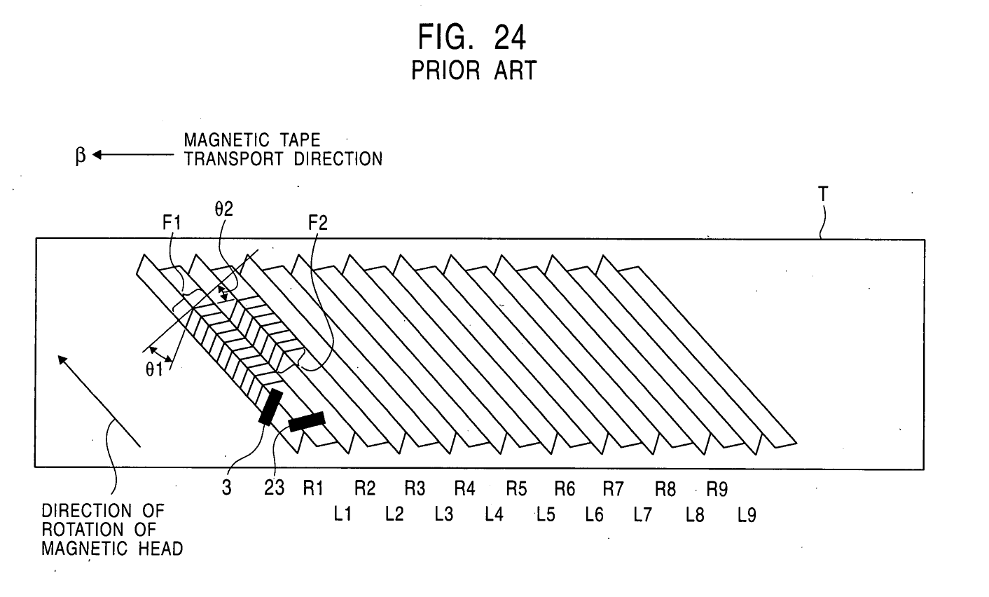

### DESCRIPTION OF THE PREFERRED EMBODIMENTS

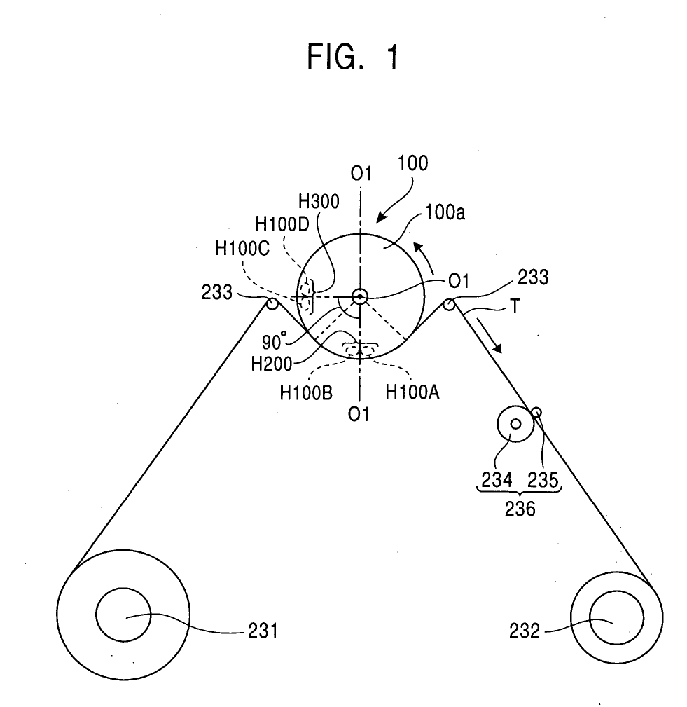

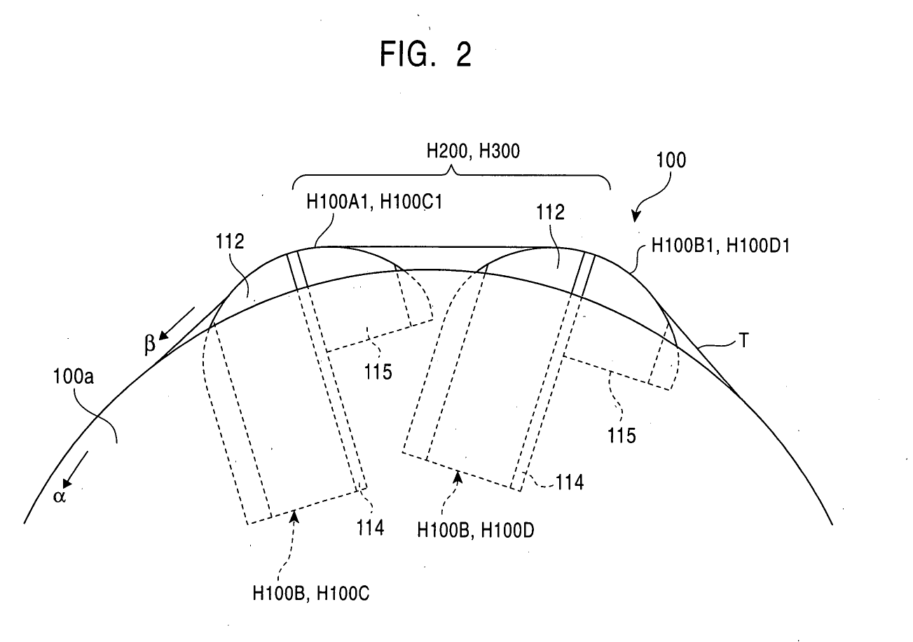

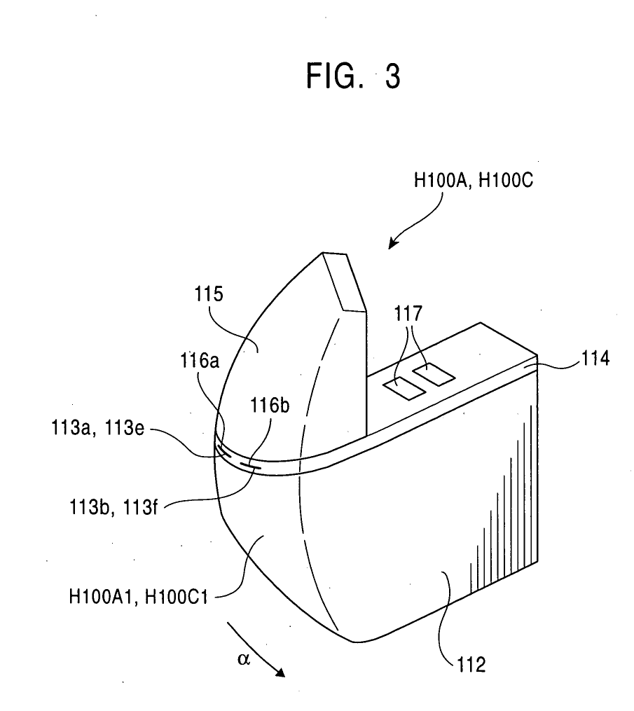

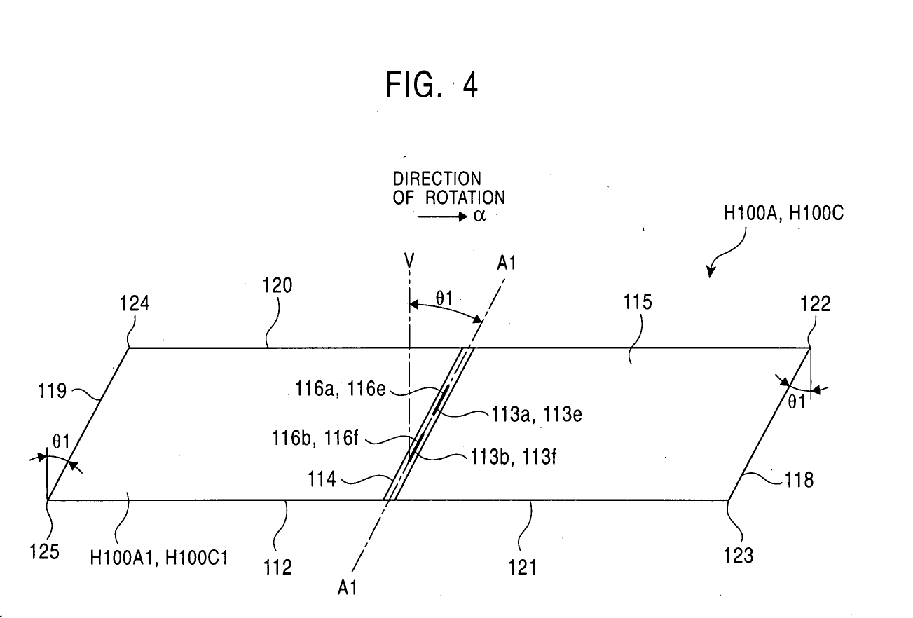

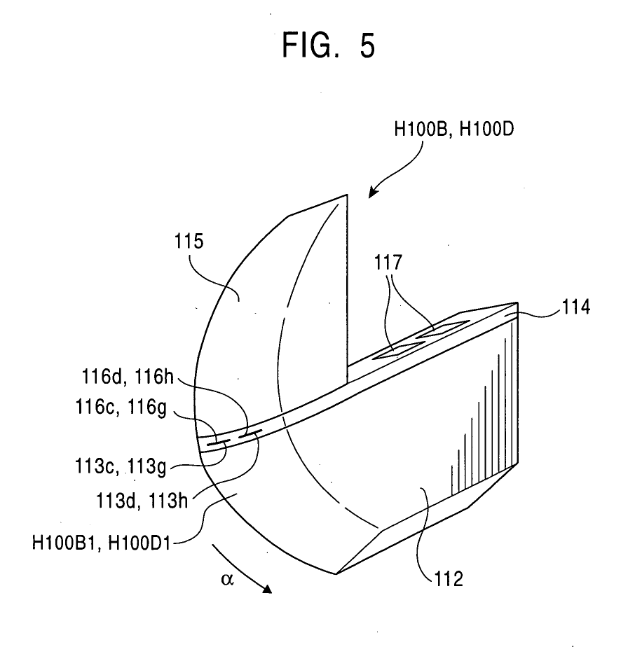

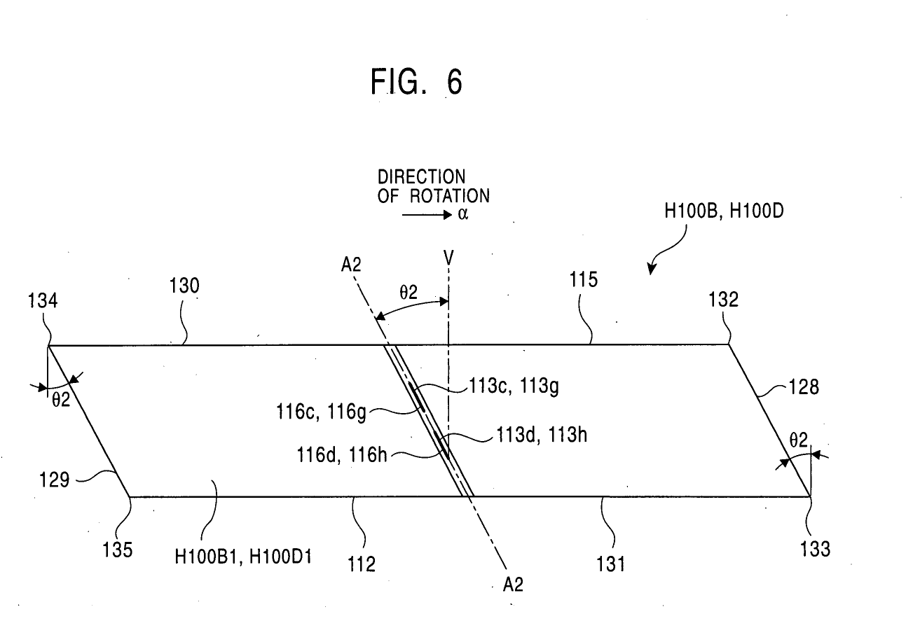

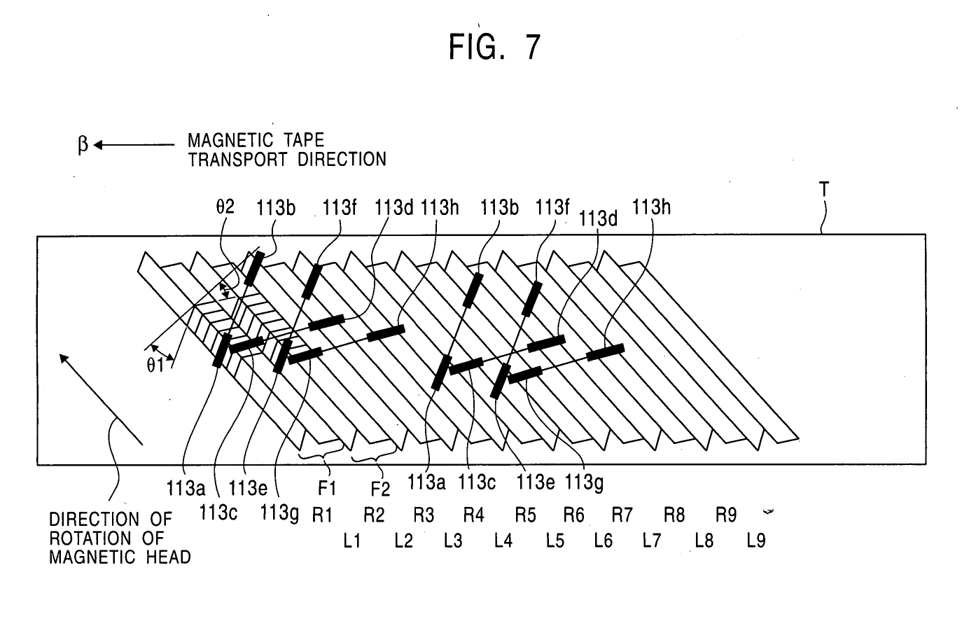

FIG. 1 is a plan view of a rotating head device of a first example of a first embodiment of the present invention that is installed in a magnetic recording/reproducing apparatus, with magnetic heads being mounted in the rotating head device. FIG. 2 is a partial enlarged view of a state in which a magnetic tape is in contact with the rotating head device shown in FIG. 1. FIG. 3 is a perspective view of an example of a magnetic head that is installed in the rotating head device. FIG. 4 is a plan view of the magnetic head shown in FIG. 3 as seen from its surface opposing the magnetic tape (that is, from a direction Y2 in FIG. 3). FIG. 5 is a perspective view of another example of a magnetic head that is installed in the rotating head device. FIG. 6 is a plan view of the magnetic head shown in FIG. 5 as seen from its surface opposing the magnetic tape (that is, from a direction Y2 in FIG. 5). FIG. 7 is a plan view showing the relationship between a recording surface of the magnetic tape and scanning by the magnetic heads.

A rotating head device 100, which is shown in FIG. 1, is installed in, for example, a magnetic recording/reproducing apparatus of a video system or a magnetic recording/reproducing apparatus for storing computer data.

In the rotating head device 100 shown in FIG. 1, a stationary drum (not shown) is fixed, and a rotating drum 10a, which is formed coaxially with the stationary drum, is rotatably supported at the stationary drum. By motor power, the rotating drum 10a is rotationally driven in a direction of an arrow marked beside the rotating drum 100a.

A supply reel hub 231, used to supply a magnetic tape T, and a take-up reel hub 232 are rotatably installed in the magnetic recording/reproducing apparatus. The magnetic tape T is wound upon both reel hubs 231 and 232.

The magnetic tape T is led out by loading posts 233, and wound upon the rotating drum 100a.

When performing a reproducing operation on the magnetic tape T, the magnetic tape T is press-contacted with a capstan 235 by a pinch roller 234, and is transported at a constant velocity V by the rotation of the capstan 235. Magnetic tape feeding means 236 comprises the pinch roller 234 and the capstan 235.

The magnetic tape T, which is a recording medium, is wound upon the rotating head device 100 at a predetermined angle in a helical path, and is transported in a direction of an arrow marked beside the magnetic tape T. During this time, the rotating drum 10a rotates, and magnetic heads H100A and H100B and magnetic heads H100C and H100D, which are mounted to the rotating drum 10a, scan the magnetic tape T.

As shown in FIG. 1, in the rotating head device 100, the magnetic heads H100A and H100B for a reproducing operation are disposed close to each other on the rotating drum 100a, and a first magnetic head composite H200 is formed by the two magnetic heads H100A and H100B. Similarly, the magnetic heads H100C and H100D are disposed close to each other on the rotating drum 100a, and a second magnetic head composite H300 is formed by the two magnetic heads H100C and H100D. As shown in FIG. 1, the magnetic head composite H300 is disposed at a rotational angle of 90 degrees from the magnetic head composite H200 in the direction of rotation of the rotating drum 100a.

It is desirable that the magnetic tape T be wound upon the rotating drum 100a at an angle that is equal to or less than 90 degrees. When the magnetic tape T is wound upon the rotating drum 100a at this winding angle, reading of recording information by the magnetic head composite H200 and reading of recording information by the magnetic head composite H300 are not carried out at the same time, so that what is called crosstalk between recording tracks can be prevented from occurring. However, when the rotating drum 100a has a large diameter, so that the aforementioned crosstalk does not occur, the magnetic tape T may be wound upon the rotating drum 10a at an angle that is greater than 90 degrees.

The magnetic heads H100A, H100B, H100C, and H100D are independently formed. With the magnetic heads H100A, H100B, H100C, and H100D being mounted to the rotating drum 100a, they come into contact with the magnetic tape T as shown in FIG. 2. Here, a direction a shown in FIG. 2 corresponds to the direction of rotation of the rotating drum 10a, and a direction β also shown in FIG. 2 corresponds to a vertical direction, which is a direction of sliding of the magnetic tape T.

The magnetic heads H100A, H100B, H100C, and H100D are formed with a convex arc shape having a curvature radius R along the vertical direction, and having a curvature radius r along a horizontal direction that is perpendicular to the vertical direction.

As shown in FIG. 3, the magnetic head H100A is formed as follows. Two reproduction magneto-resistive (MR) thin-film magnetic heads 113a and 113b and an insulating layer 114 (protective layer) are formed on a base 112 (formed of alumina titanium carbide) by a thin-film formation process. Then, a protective base 115 (formed of alumina titanium carbide) is adhered to the insulating layer 114 using adhering means (not shown), such as an epoxy adhesive.

Magnetic gaps 116a and 116b of the MR thin-film magnetic heads 113a and 113b appear at a magnetic-tape-opposing surface H100A1 of the magnetic head H100A. Electrical current that flows to the MR thin-film magnetic heads 113a and 113b is supplied thereto through electrodes 117.

The magnetic heads H100B, H100C, and H100D are similarly formed to the magnetic head H100A. They each comprise a base 112 (formed of alumina titanium carbide), an insulating layer 114 (which is a protective layer), a protective base 115, and electrodes 117.

As shown in FIG. 5, in the magnetic head H100B, two reproduction MR thin-film magnetic heads 113c and 113d are formed, and magnetic gaps 116c and 116d of the MR thin-film magnetic heads 113c and 113d appear at a magnetic-tape-opposing surface H100B1 of the magnetic head H100B.

In the magnetic head H100C, two reproduction MR thin-film magnetic heads 113e and 113f are formed, and magnetic gaps 116e and 116f of the MR thin-film magnetic heads 113e and 113f appear at a magnetic-tape-opposing surface H100C1 of the magnetic head H100C.

In the magnetic head H100D, two reproduction MR thin-film magnetic heads 113g and 113h are formed, and magnetic gaps 116g and 116h of the MR thin-film magnetic heads 113g and 113h appear at a magnetic-tape-opposing surface H100D1 of the magnetic head H100D.

The recording/reproducing apparatus makes use of what is called a helical scan method. Therefore, as shown in FIG. 4 and FIG. 6, a predetermined azimuth angle is formed at magnetic reproducing elements of each of the MR magnetic heads H100A, H100B, H100C, and H100D with respect to a vertical line V in the direction of rotation of the rotating drum 100a (that is, a scanning direction of the magnetic reproducing elements with respect to the magnetic tape T).

In other words, as shown in FIG. 4, in the magnetic head H100A of the magnetic head composite H200, a first azimuth angle θ1 is formed at the magnetic gaps 116a and 116b of the MR magnetic heads 113a and 113b by a line that inclines in one direction from the vertical line V in the direction of rotation. In the magnetic head H100C of the magnetic head composite H300 also, the first azimuth angle θ1 is formed at the magnetic gaps 116e and 116f of the MR magnetic heads 113e and 113f.

As shown in FIG. 6, in the magnetic head H100B of the magnetic head composite H200, a second azimuth angle θ2 is formed at the magnetic gaps 116c and 116d of the MR magnetic heads 113c and 113d. In the magnetic head H100D of the magnetic head composite H300 also, the second azimuth angle θ2 is formed at the magnetic gaps 116g and 116h of the MR magnetic heads 113g and 113h. The second azimuth angle θ2 is formed by a line that inclines in a direction opposite to the direction in which the line that forms the first azimuth angle θ1 inclines. The absolute positions where the angles θ1 and θ2 are formed are generally equal to each other.

In other words, in the magnetic head composite H200, the two magnetic reproducing elements of the magnetic head H100A are formed at the same azimuth angle, and the two magnetic reproducing elements of the magnetic head H100B are formed at the same azimuth angles as well. The azimuth angles at which the magnetic reproducing elements of the magnetic head H100A and those of the magnetic head H100B are formed are formed by lines that incline in opposite directions from the vertical line V. Similarly, in the magnetic head composite H300, the azimuth angles at which the magnetic reproducing elements of the magnetic head H100C and those of the magnetic head H100D are formed are formed by lines that incline in opposite directions from the vertical line V.

In the magnetic heads H100A and H100C, the MR thin-film magnetic heads 113a and 113b and the MR thin-film magnetic heads 113e and 113f are disposed in parallel in the longitudinal direction along an azimuth reference line A1-A1 that defines the first azimuth angle. In the magnetic heads H100B and H100D, the MR thin-film magnetic heads 113c and 113d and the MR thin-film magnetic heads 113g and 113h are disposed in parallel in the longitudinal direction along an azimuth reference line A2-A2 that defines the second azimuth angle.

In this way, when the MR thin-film magnetic heads 113a and 113b and the MR thin-film magnetic heads 113e and 113f are formed so that they are disposed in parallel along the azimuth reference line A1-A1, and when the MR thin-film magnetic heads 113c and 113d and the MR thin-film magnetic heads 113g and 113h are formed so that they are disposed in parallel along the azimuth reference line A2-A2, the MR thin-film magnetic heads 113a and 113b and the MR thin-film magnetic heads 113e and 13f, and the MR thin-film magnetic heads 113c and 113d and the MR thin-film magnetic heads 113g and 113h can be formed at substantially the same time on the same flat surface. Therefore, it is possible to form two MR thin-film magnetic heads in one magnetic head with a uniform quality.

The magnetic head H100A of the magnetic head composite H200 and the magnetic head H100C of the magnetic tape composite H300 have the same structure. Right edges 118 and left edges 119 of the tape-opposing surfaces H100A1 and H100C1 of the respective magnetic heads H100A and H100C are also tilted by an angle θ1, which is equal to the first azimuth angle. Each acute angled portion 122, formed by intersection of the right edge 118 and an upper edge 120, is disposed more outward in the vertical direction than its associated angled portion 123, formed by intersection of the right edge 118 and a lower edge 121. Each angled portion 125, formed by intersection of the left edge 119 and the lower edge 121, is disposed more outward in the vertical direction than its associated acute angled portion 124, formed by intersection of the left edge 119 and the upper edge 120. Therefore, the tape-opposing surfaces H100A1 and H100B1 in plan view and as seen from the magnetic tape has the shape of a parallelogram, as shown in FIG. 4.

The magnetic head H100B of the magnetic head composite H200 and the magnetic head H100D of the magnetic tape composite H300 have the same structure. As shown in FIG. 5, the magnetic heads H100B and H100D are formed at the second azimuth angle.

Right edges 128 and left edges 129 of the tape-opposing surfaces H100B1 and H100D1 of the respective magnetic heads H100B and H100D are also tilted by an angle θ2, which is equal to the second azimuth angle at the magnetic gaps. Each acute angled portion 133, formed by intersection of the right edge 128 and a lower edge 131, is disposed more outward in the vertical direction than its associated angled portion 132, formed by intersection of the right edge 128 and an upper edge 130. Each angled portion 134, formed by intersection of a left edge 129 and the upper edge 130, is disposed more outward in the vertical direction than its associated acute angled portion 135, formed by intersection of the left edge 129 and the lower edge 131. Therefore, as shown in FIG. 5, the tape-opposing surfaces H100B1 and H100D1 in plan view and as seen from the magnetic tape have the shape of a parallelogram whose vertical sides are tilted in a direction opposite to the direction in which the vertical sides are tilted in the magnetic heads H100A and H100C.

As shown in FIG. 7, two types of recording tracks, that is, tracks R (R1, R2, R3, etc.) having signals recorded at the first azimuth angle θ1 and tracks L (L1, L2, L3, etc.) having signals recorded at the second azimuth angle θ2 are alternately adjacently formed on the magnetic tape T. A frame F1 is formed by two tracks, the tracks R1 and L1. In the same way, a frame F2 is formed by two tracks, the tracks R2 and L2. By the frames F1 and F2, for example, one image plane is formed between vertical synchronizing signals. In this way, a frame Fn is formed by recording tracks Rn and Ln.

As shown in FIG. 7, in the rotating head device 100, when the magnetic head composite H200 scans the magnetic tape T having the tracks R and tracks L formed thereon, the MR thin-film magnetic heads 113a and 113b of the magnetic head H100A scan tracks R and read recording signals. On the other hand, the MR thin-film magnetic heads 113c and 113d of the magnetic head H100B scan tracks L and read recording signals.

When the magnetic head composite H300 scans the magnetic tape T, the MR thin-film magnetic heads 113e and 113f of the magnetic head H100C scan tracks R and read recording signals. On the other hand, the MR thin-film magnetic heads 113g and 113h of the magnetic head H100D scan tracks L and read recording signals.

Hereunder, the relationship between the rotation of the rotating head device 100 and the scanning of the recording tracks of the recording tape T will be described.

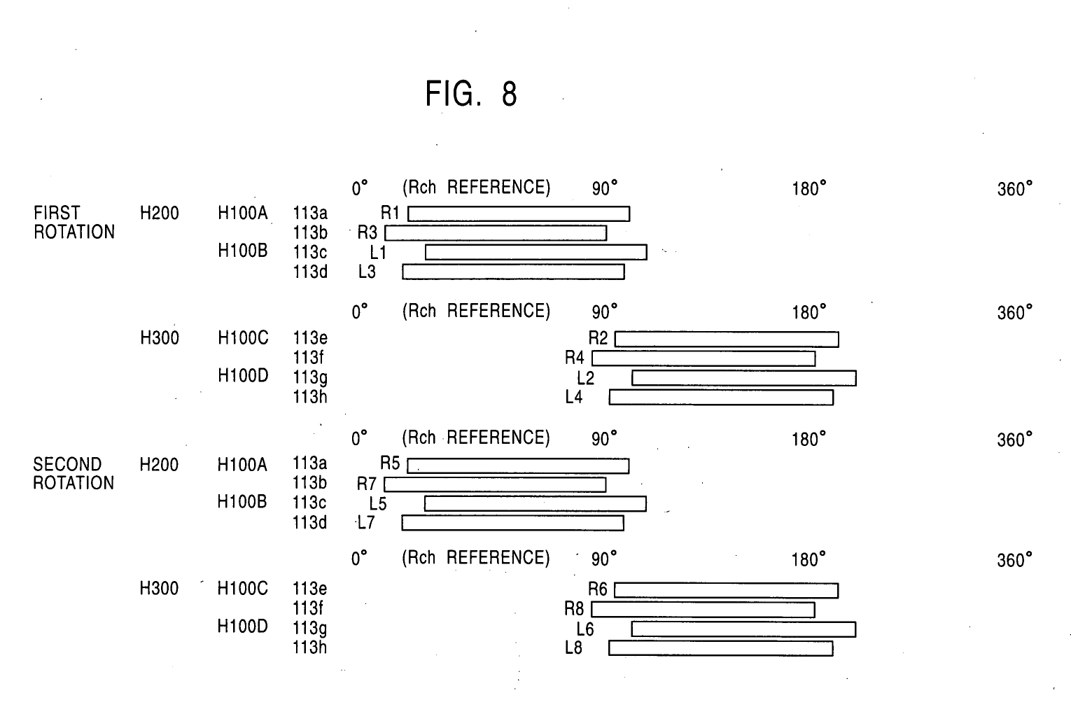

FIG. 8 shows the relationship between the rotation of the rotating drum 10a and the scanning of the recording tracks by the MR thin-film magnetic heads 113a and 113b of the magnetic head H100A, the MR thin-film magnetic heads 113c and 113d of the magnetic head H100B, the MR thin-film magnetic heads 113e and 113f of the magnetic head H100C, and the MR thin-film magnetic heads 113g and 113h of the magnetic head H100D.

As shown in FIGS. 7 and 8, in a first rotation of the rotating drum 100a in a range of angles of from 0 to 90 degrees, first, the magnetic head H100A of the magnetic head composite H200 comes into contact with and slides along the magnetic tape T. Here, first, the MR thin-film magnetic head 113b scans the recording track R3 of the magnetic tape T, and the MR thin-film magnetic head 113a scans the recording track R1 of the magnetic tape T in order to read recording information. Next, the magnetic head H100B of the magnetic head composite H200 comes into contact with and slides along the magnetic tape T. Here, the MR thin-film magnetic head 113d scans the recording track L3 of the magnetic tape T, and the MR thin-film magnetic head 113c scans the recording track L1 of the magnetic tape T in order to read recording information.

Next, when the rotating drum 100a is rotated from 90 to 180 degrees, the magnetic head composite H300 comes into contact with and slides along the magnetic tape T, and scans recording tracks. Here, the magnetic head composites H200 and H300 are disposed on the rotating drum 100a so that the MR thin-film magnetic heads 113e and 113f of the magnetic head H100C of the magnetic head composite H300 and the MR thin-film magnetic heads 113g and 113h of the magnetic head H100D of the magnetic head composite H300 scan recording tracks that are adjacent to the recording tracks that have been scanned by the MR thin-film magnetic heads 113a and 113b of the magnetic head H100A of the magnetic head composite H200 and the MR thin-film magnetic heads 113c and 113d of the magnetic head H100B of the magnetic head composite H200. From the start of the scanning of the recording tracks by the magnetic head composite H200 to the time the magnetic head composite H300 starts scanning the recording tracks, the magnetic tape T is transported by an amount corresponding to two tracks.

In other words, when the rotating drum 100a is rotated from 90 to 180 degrees, the magnetic head H100C of the magnetic head composite H300 comes into contact with and slides along the magnetic tape T. Here, first, the MR thin-film magnetic head 113f scans the recording track R4 of the magnetic tape T, and the MR thin-film magnetic head 113e scans the recording track R2 of the magnetic tape T in order to read recording information. Next, the magnetic head H100D of the magnetic head composite H300 comes into contact with and slides along the magnetic tape T. Here, the MR thin-film magnetic head 113h scans the recording track L4 of the magnetic tape T, and the MR thin-film magnetic head 113g scans the recording track L2 of the magnetic tape T in order to read recording information.

Next, the rotating drum 100a starts to rotate for the second time. Here, from the start of the scanning of the recording tracks by the magnetic head composite H300 to the time the magnetic head composite H200 starts scanning recording tracks, the magnetic tape T is transported by an amount corresponding to six tracks.

As shown in FIG. 8, in the second rotation of the rotating drum 100a in the range of angles of from 0 to 90 degrees, first, the magnetic head H100A of the magnetic head composite H200 comes into contact with and slides along the magnetic tape T. Here, first, the MR thin-film magnetic head 113b scans the recording track R7 of the magnetic tape T, and the MR thin-film magnetic head 113a scans the recording track R5 of the magnetic tape T in order to read recording information. Next, the magnetic head H100B of the magnetic head composite H200 comes into contact with and slides along the magnetic tape T. Here, the MR thin-film magnetic head 113d scans the recording track L7 of the magnetic tape T, and the MR thin-film magnetic head 113c scans the recording track L5 of the magnetic tape T in order to read recording information.

Next, when the rotating drum 10a is rotated from 90 to 180 degrees, the magnetic head composite H300 comes into contact with and slides along the magnetic tape T again. The MR thin-film magnetic heads 113e and 113f of the magnetic head H100C of the magnetic head composite H300 and the MR thin-film magnetic heads 113g and 113h of the magnetic head H100D of the magnetic head composite H300 scan recording tracks that are adjacent to the recording tracks that have been scanned by the MR thin-film magnetic heads 113a and 113b of the magnetic head H100A of the magnetic head composite H200 and the MR thin-film magnetic heads 113c and 113d of the magnetic head H100B of the magnetic head composite H200. From the start of the scanning of the recording tracks by the magnetic head composite H200 to the time the magnetic head composite H300 starts scanning the recording tracks, the magnetic tape T is transported by an amount corresponding to two tracks.

In other words, when the rotating drum 100a is rotated from 90 to 180 degrees, the magnetic head H100C of the magnetic head composite H300 comes into contact with and slides along the magnetic tape T. Here, first, the MR thin-film magnetic head 113f scans the recording track R8 of the magnetic tape T, and the MR thin-film magnetic head 113e scans the recording track R6 of the magnetic tape T in order to read recording information. Next, the magnetic head H100D of the magnetic head composite H300 comes into contact with and slides along the magnetic tape T. Here, the MR thin-film magnetic head 113h scans the recording track L8 of the magnetic tape T, and the MR thin-film magnetic head 113g scans the recording track L6 of the magnetic tape T in order to read recording information.

In this way, the rotating drum 100a subsequently rotates continuously in order to read recording information.

Accordingly, since the magnetic heads H100A, H100B, H100C, and H100D each comprise two MR thin-film magnetic heads, it is not necessary to increase the number of magnetic heads that are mounted to the rotating drum 100a in order to increase transfer rate, so that costs are reduced. By the narrowing of tracks with the increase of recording density in recent years, it is becoming difficult to adjust the scanning positions of the MR thin-film magnetic heads to the positions of the recording tracks of the magnetic tape. When the number of magnetic heads is increased, it is even more difficult to adjust the scanning positions of the MR thin-film magnetic heads to the positions of the recording tracks. In the rotating head device 100, however, it is not necessary to increase the number of magnetic heads, so that it is easy to adjust the scanning positions of the MR thin-film magnetic heads 113a, 113b, 113c, 113d, 113e, 113f, 113g, and 113h to the positions of the recording tracks.

Since the magnetic head composites H200 and H300 are disposed 90 degrees apart on the rotating drum 10a, the magnetic heads H100A, H100B, H100C, and H100D can be easily disposed at the rotating drum 100a.

In the magnetic recording/reproducing apparatus in which the rotating head device 100 is installed, each time the rotating drum 100a rotates once, recording information stored along a total of eight tracks (four recording tracks formed at the azimuth angle formed by a line inclined in one direction, and four recording tracks formed at the azimuth angle formed by a line inclined in the other direction) can be read. Therefore, the information recorded along the recording tracks of the magnetic tape T is read with greater efficiency, so that it is possible to increase the transfer rate of the magnetic tape T.

Here, in the first scanning, for example, the MR thin-film magnetic heads 113a and 113b of the magnetic head H100A read at the same time the recording information stored along the recording tracks R1 and R3, but do not read the recording information stored along the recording track R2. In the second scanning, the MR thin-film magnetic heads 113a and 113b read at the same time the recording information stored along the recording tracks R5 and R7, but do not read the recording information stored along the recording track R6.

Similarly, in the first scanning, the MR thin-film magnetic heads 113c and 113d of the magnetic head H100B read at the same time the recording information stored along the recording tracks L1 and L3, but do not read the recording information stored along the recording track L2. In the second scanning, the MR thin-film magnetic heads 113c and 113d read at the same time the recording information stored along the recording tracks L5 and L7, but do not read the recording information stored along the recording track L6.

In the first scanning, the MR thin-film magnetic heads 113e and 113f of the magnetic head H100C read at the same time the recording information stored along the recording tracks R2 and R4, but do not read the recording information stored along the recording track R3. In the second scanning, the MR thin-film magnetic heads 113e and 113f read at the same time the recording information stored along the recording tracks R6 and R8, but do not read the recording information stored along the recording track R7.

In the first scanning, the MR thin-film magnetic heads 113g and 113h of the magnetic head H100D read at the same time the recording information stored along the recording tracks L2 and L4, but do not read the recording information stored along the recording track L3. In the second scanning, the MR thin-film magnetic heads 113g and 113h read at the same time the recording information stored along the recording tracks L6 and L8, but do not read the recording information stored along the recording track L7.

Accordingly, in the magnetic recording/reproducing apparatus in which the rotating head device 100 is installed, recording tracks having one track disposed therebetween among the plurality of recording tracks formed at the same azimuth angle are scanned at the same time to read the recording information stored along the recording tracks. By virtue of such a structure, the MR thin-film magnetic heads 113a and 113b, the MR thin-film magnetic heads 113c and 113d, the MR thin-film magnetic heads 113e and 113f, and the MR thin-film magnetic heads 113g and 113h can be formed with large intervals therebetween in the longitudinal direction. Therefore, even if tracks are narrowed with increasing recording density, it is possible to dispose structural portions, such as hard bias layers, at respective end portions of the MR thin-film magnetic heads 113a and 113b, the MR thin-film magnetic heads 113c and 113d, the MR thin-film magnetic heads 113e and 113f, and the MR thin-film magnetic heads 113g and 113h.

A recording signal processor (not shown), which is disposed in the magnetic recording/reproducing apparatus, makes a detection as to whether or not the MR thin-film magnetic heads 113a and 113b, the MR thin-film magnetic heads 113c and 113d, the MR thin-film magnetic heads 113e and 113f, and the MR thin-film magnetic heads 113g and 113h have failed to read the pieces of recording information. If it makes a detection that a reading failure has occurred, the recording signal processor transmits a signal indicating the occurrence of the reading failure to a controller (not shown). The controller controls a motor (not shown) for rotationally driving the rotating drum 10a and the rotation of the capstan, and rewinds the magnetic tape in order to re-read the recording signals.

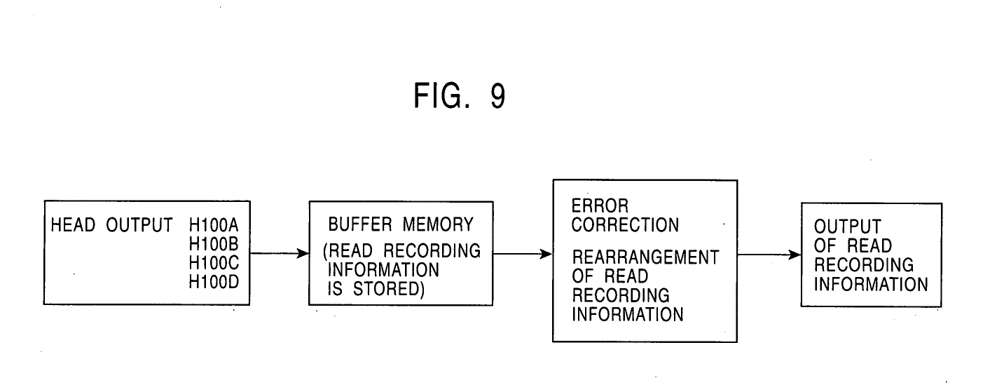

One image plane between vertical synchronizing signals is formed by the frame F1 and the frame F2 on the magnetic tape T on which the recording information is recorded. Therefore, the order in which the recording information is read does not correspond to the order in which the recording information is reproduced. However, as shown in FIG. 9, the pieces of recording information read by the magnetic heads H100A, H100B, H100C, and H100D are stored in a buffer memory, errors are corrected, and the pieces of recording information are re-arranged in the order in which they are reproduced. Then, the read pieces of recording information are output.

Although, in the rotating head device 100, two magnetic head composites H200 and H300 are mounted to the rotating drum 10a, the present invention is not limited thereto. For example, a total of three magnetic head composites may be mounted to the rotating drum 10a. In this case, for example, when, of the three magnetic head composites, the magnetic head composite H200 is at the 0 degree position, the other two magnetic head composites are at the 90 degree and 180 degree positions in the direction of rotation of the rotating drum 100a.

In the magnetic head device 100, a total of four magnetic head composites may also be mounted to the rotating drum 10a. In this case, for example, when, of the four magnetic head composites, the magnetic head composite H200 is disposed at the 0 degree position, the other three magnetic head composites are disposed at the 90 degree, 180 degree, and 270 degree positions in the direction of rotation of the rotating drum 100a.

In this way, when the magnetic head device 100 comprises three or four magnetic head composites that are mounted to the rotating drum 100a, the third magnetic head composite or the fourth magnetic head composite can re-scan the recording tracks on the magnetic tape T that have already been scanned by the first magnetic head composite H200 and the second magnetic head composite H300 in order to read the recording information. Therefore, it is possible to prevent a reduction in the transfer rate of the magnetic tape T and to omit the task of re-reading recording information when there is a reading failure.

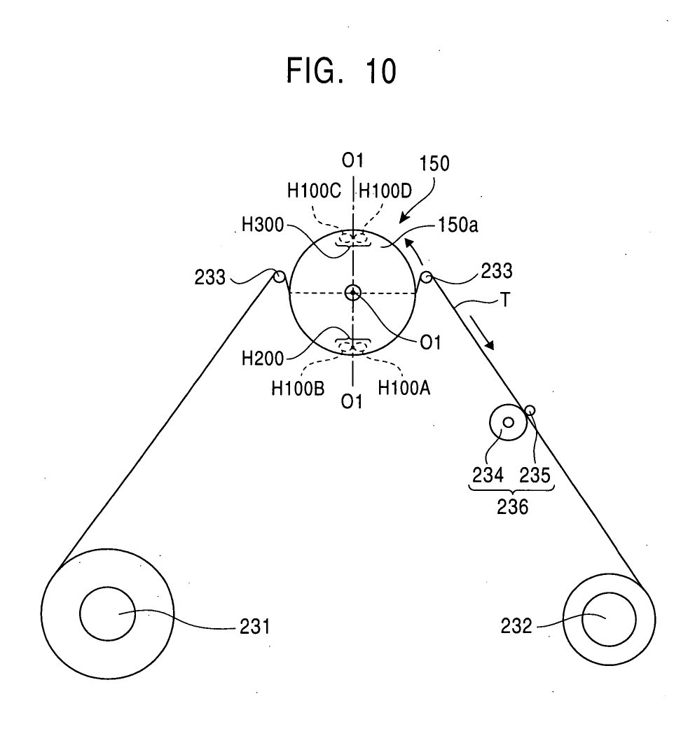

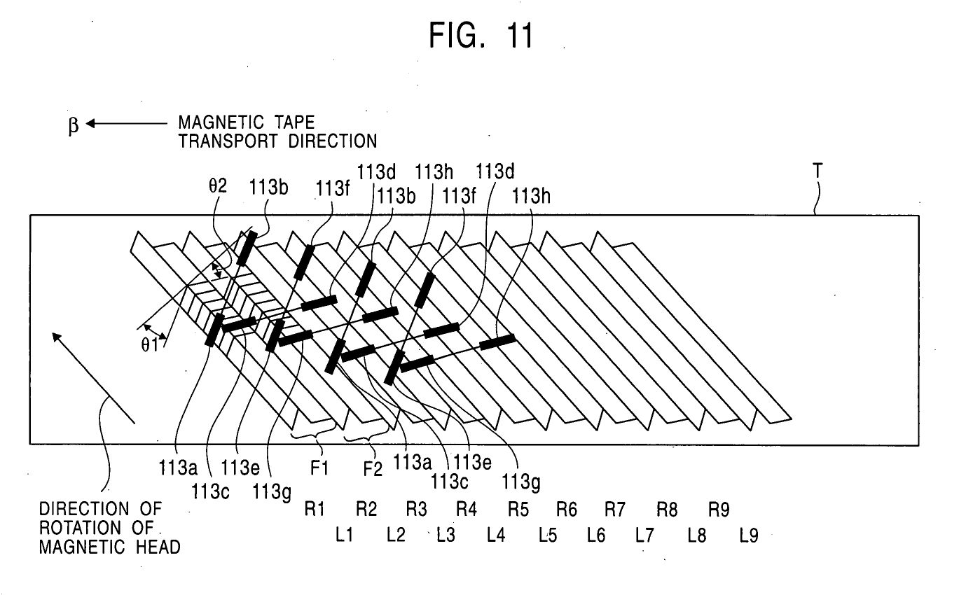

FIG. 10 is a plan view of a rotating head device of a second example of the first embodiment of the present invention that is installed in a magnetic recording/reproducing apparatus, with magnetic heads being installed in the rotating head device. FIG. 11 is a plan view showing the relationship between recording tracks of a magnetic tape and scanning by the magnetic heads.

A rotating head device 150, which is shown in FIG. 10, is installed in, for example, a magnetic recording/reproducing apparatus of a video system or a magnetic recording/reproducing apparatus for storing computer data.

The rotating head device 150 has substantially the same structure as the rotating head device 100 shown in FIG. 1. Therefore, of the structural parts of the rotating head device 150 shown in FIG. 10, the structural parts that correspond to those of the rotating head device 100 shown in FIG. 1 are given the same reference numerals, and will not be described in detail below. Hereunder, a description of the rotating head device 150 will be given focusing on the differences between the rotating head device 150 and the rotating head device 100.

In the rotating head device 150 shown in FIG. 10, a stationary drum (not shown) is fixed, and a rotating drum 150a, which is formed coaxially with the stationary drum, is rotatably supported at the stationary drum. By motor power, the rotating drum 150a is rotationally driven in a direction of an arrow marked beside the rotating drum 150a.

As shown in FIG. 10, as in the rotating head device 100 shown in FIG. 1, in the rotating head device 150, a first magnetic head composite H200 comprising reproduction magnetic heads H100A and H100B and a second magnetic head composite H300 comprising reproduction magnetic heads H100C and H100D are disposed at the rotating drum 150a. However, unlike the rotating head device 100 shown in FIG. 1, the rotating head device 150 is such that the magnetic head composites H200 and H300 are disposed at a rotational angle of 180 degrees apart from each other at the rotating drum 150a, that is, are disposed opposing each other on a central line 01-01 passing through a central point 01 of the rotating drum 150a.

It is desirable that a magnetic tape T be wound upon the rotating drum 150a at a winding angle that is equal to or less than 180 degrees. When the magnetic tape T is wound upon the rotating drum 150a at this winding angle, reading of recording information by the magnetic head composite H200 and reading of recording information by the magnetic head composite H300 are not carried out at the same time, so that what is called crosstalk can be prevented from occurring.

As shown in FIG. 11, two types of recording tracks, that is, tracks R (R1, R2, R3, etc.) having signals recorded at the first azimuth angle θ1 and tracks L (L1, L2, L3, etc.) having signals recorded at the second azimuth angle θ2 are alternately adjacently formed on the magnetic tape T. A frame F1 is formed by two tracks, the tracks R1 and L1. In the same way, a frame F2 is formed by two tracks, the tracks R2 and L2. By the frames F1 and F2, for example, one image plane is formed between vertical synchronizing signals. In this way, a frame Fn is formed by recording tracks Rn and Ln.

As in the rotating head device 100 shown in FIG. 1, in the rotating head device 150, as shown in FIG. 11, when the magnetic head composite H200 scans the magnetic tape T having the tracks R and tracks L formed thereon, MR thin-film magnetic heads 113a and 113b of the magnetic head H100A scan tracks R and read recording signals. On the other hand, MR thin-film magnetic heads 113c and 113d of the magnetic head H100B scan tracks L and read recording signals.

When the magnetic head composite H300 scans the magnetic tape T, MR thin-film magnetic heads 113e and 113f of the magnetic head H100C scan tracks R and read recording signals. On the other hand, MR thin-film magnetic heads 113g and 113h of the magnetic head H100D scan tracks L and read recording signals.

Hereunder, the relationship between the rotation of the rotating head device 150 and the scanning of the recording tracks of the recording tape T will be described.

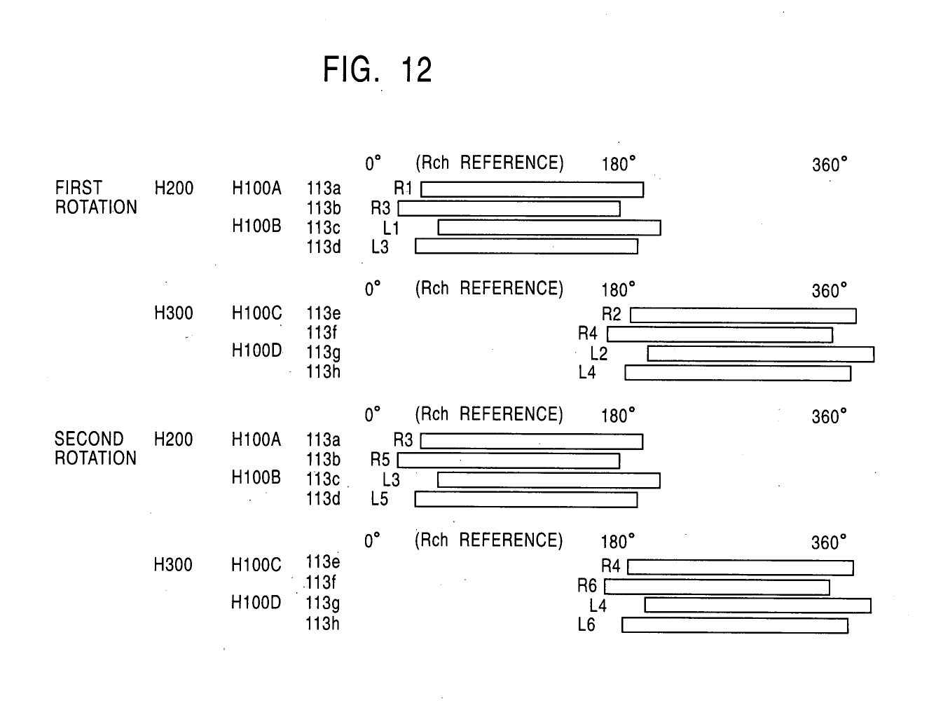

FIG. 12 shows the relationship between the rotation of the rotating drum 150a and the scanning of the recording tracks by MR thin-film magnetic heads 113a and 113b of the magnetic head H100A, MR thin-film magnetic heads 113c and 113d of the magnetic head H100B, the MR thin-film magnetic heads 113e and 113f of the magnetic head H100C, and the MR thin-film magnetic heads 113g and 113h of the magnetic head H100D.

As shown in FIGS. 11 and 12, in a first rotation of the rotating drum 150a in a range of angles of from 0 to 180′ degrees, first, the magnetic head H100A of the magnetic head composite H200 comes into contact with and slides along the magnetic tape T. Here, first, the MR thin-film magnetic head 113b scans the recording track R3 of the magnetic tape T, and the MR thin-film magnetic head 113a scans the recording track R1 of the magnetic tape T in order to read recording information. Next, the magnetic head H100B of the magnetic head composite H200 comes into contact with and slides along the magnetic tape T. Here, the MR thin-film magnetic head 113d scans the recording track L3 of the magnetic tape T, and the MR thin-film magnetic head 113c scans the recording track L1 of the magnetic tape T in order to read recording information.

Next, when the rotating drum 150a is rotated from 180 to 360 degrees, the magnetic head composite H300 comes into contact with and slides along the magnetic tape T, and scan recording tracks. Here, the magnetic head composites H200 and H300 are disposed on the rotating drum 150a so that the MR thin-film magnetic heads 113e and 113f of the magnetic head H100C of the magnetic head composite H300 and the MR thin-film magnetic heads 113g and 113h of the magnetic head H100D of the magnetic head composite H300 scan recording tracks that are adjacent to the recording tracks that have been scanned by the MR thin-film magnetic heads 113a and 113b of the magnetic head H100A of the magnetic head composite H200 and the MR thin-film magnetic heads 113c and 113d of the magnetic head H100B of the magnetic head composite H200. From the start of the scanning of the recording tracks by the magnetic head composite H200 to the time the magnetic head composite H300 starts scanning the recording tracks, the magnetic tape T is transported by an amount corresponding to two tracks.

In other words, when the rotating drum 150a is rotated from 180 to 360 degrees, the magnetic head H100C of the magnetic head composite H300 comes into contact with and slides along the magnetic tape T. Here, first, the MR thin-film magnetic head 113f scans the recording track R4 of the magnetic tape T, and the MR thin-film magnetic head 113e scans the recording track R2 of the magnetic tape T in order to read recording information. Next, the magnetic head H100D of the magnetic head composite H300 comes into contact with and slides along the magnetic tape T. Here, the MR thin-film magnetic head 113h scans the recording track L4 of the magnetic tape T, and the MR thin-film magnetic head 113g scans the recording track L2 of the magnetic tape T in order to read recording information.

Next, the rotating drum 150a starts to rotate for the second time. Here, from the start of the scanning of the recording tracks by the magnetic head composite H300 to the time the magnetic head composite H200 starts scanning the recording tracks, the magnetic tape T is transported by an amount corresponding to two tracks.

As shown in FIG. 12, in the second rotation of the rotating drum 150a in the range of angles of from 0 to 180 degrees, first, the magnetic head H100A of the magnetic head composite H200 comes into contact with and slides along the magnetic tape T. Here, first, the MR thin-film magnetic head 113b scans the recording track R5 of the magnetic tape T, and the MR thin-film magnetic head 113a scans the recording track R3 of the magnetic tape T in order to read recording information. Next, the magnetic head H100B of the magnetic head composite H200 comes into contact with and slides along the magnetic tape T. Here, the MR thin-film magnetic head 113d scans the recording track L5 of the magnetic tape T, and the MR thin-film magnetic head 113c scans the recording track L3 of the magnetic tape T in order to read recording information.

Next, when the rotating drum 150a is rotated from 180 to 360 degrees, the magnetic head composite H300 comes into contact with and slides along the magnetic tape T again. The MR thin-film magnetic heads 113e and 113f of the magnetic head H100C of the magnetic head composite H300 and the MR thin-film magnetic heads 113g and 113h of the magnetic head H100D of the magnetic head composite H300 scan recording tracks that are adjacent to the recording tracks that have been scanned by the MR thin-film magnetic heads 113a and 113b of the magnetic head H100A of the magnetic head composite H200 and the MR thin-film magnetic heads 113c and 113d of the magnetic head H100B of the magnetic head composite H200. From the start of the scanning of the recording tracks by the magnetic head composite H200 to the time the magnetic head composite H300 starts scanning the recording tracks, the magnetic tape T is transported by an amount corresponding to two tracks.

In other words, when the rotating drum 150a is rotated from 180 to 360 degrees, the magnetic head H100C of the magnetic head composite H300 comes into contact with and slides along the magnetic tape T. Here, first, the MR thin-film magnetic head 113f scans the recording track R6 of the magnetic tape T, and the MR thin-film magnetic head 113e scans the recording track R4 of the magnetic tape T in order to read recording information. Next, the magnetic head H100D of the magnetic head composite H300 comes into contact with and slides along the magnetic tape T. Here, the MR thin-film magnetic head 113h scans the recording track L6 of the magnetic tape T, and the MR thin-film magnetic head 113g scans the recording track L4 of the magnetic tape T in order to read recording information.

In this way, the rotating drum 150a subsequently rotates continuously in order to read recording information.

In this way, as in the rotating head device 100, in the rotating head device 150 also, since the magnetic heads H100A, H100B, H100C, and H100D each comprise two MR thin-film magnetic heads, costs are reduced, and it is easy to adjust the scanning positions of the MR thin-film magnetic heads to the positions of the recording tracks.

Here, in the first scanning, for example, the MR thin-film magnetic heads 113a and 113b of the magnetic head H100A read at the same time the recording information stored along the recording tracks R1 and R3, but do not read the recording information stored along the recording track R2. In the second scanning, the MR thin-film magnetic heads 113a and 113b read at the same time the recording information stored along the recording tracks R3 and R5, but do not read the recording information stored along the recording track R4.

Similarly, in the first scanning, the MR thin-film magnetic heads 113c and 113d of the magnetic head H100B read at the same time the recording information stored along the recording tracks L1 and L3, but do not read the recording information stored along the recording track L2. In the second scanning, the MR thin-film magnetic heads 113c and 113d read at the same time the recording information stored along the recording tracks L3 and L5, but do not read the recording information stored along the recording track L4.

In the first scanning, the MR thin-film magnetic heads 113e and 113f of the magnetic head H100C read at the same time the recording information stored along the recording tracks R2 and R4, but do not read the recording information stored along the recording track R3. In the second scanning, the MR thin-film magnetic heads 113e and 113f read at the same time the recording information stored along the recording tracks R4 and R6, but do not read the recording information stored along the recording track R5.

In the first scanning, the MR thin-film magnetic heads 113g and 113h of the magnetic head H100D read at the same time the recording information stored along the recording tracks L2 and L4, but do not read the recording information stored along the recording track L3. In the second scanning, the MR thin-film magnetic heads 113g and 113h read at the same time the recording information stored along the recording tracks L4 and L6, but do not read the recording information stored along the recording track L5.

Accordingly, in the magnetic recording/reproducing apparatus in which the rotating head device 150 is installed, recording track having one track disposed therebetween among the plurality of recording tracks formed at the same azimuth angle are scanned at the same time to read the read recording information. By virtue of such a structure, the MR thin-film magnetic heads 113a and 113b, the MR thin-film magnetic heads 113c and 113d, the MR thin-film magnetic heads 113e and 113f, and the MR thin-film magnetic heads 113g and 113h can be formed with large intervals therebetween in the longitudinal direction. Therefore, even if tracks are narrowed due to increasing recording density, it is possible to dispose structural portions, such as hard bias layers, at respective end portions of the MR thin-film magnetic heads 113a and 113b, the MR thin-film magnetic heads 113c and 113d, the MR thin-film magnetic heads 113e and 113f, and the MR thin-film magnetic heads 113g and 113h.

In the magnetic recording/reproducing apparatus in which the rotating head device 150 is installed, each time the rotating drum 150a rotates once, recording information stored along a total of eight tracks (four recording tracks formed at the azimuth angle formed by a line inclined in one direction, and four recording tracks formed at the azimuth angle formed by a line inclined in the other direction) can be read. However, in the magnetic recording/reproducing apparatus in which the rotating head device 150 is installed, from the second rotation onwards, the recording information stored along the tracks R and tracks L that has been read is re-read by the MR thin-film magnetic heads 113a, 113c, 113e, and 113g.

In the aforementioned example, in the first rotation of the rotating drum 150a, the MR thin-film magnetic head 113b of the magnetic head H100A reads the recording information stored along the track R3, the MR thin-film magnetic head 113d of the magnetic head H100B reads the recording information stored along the track L3, the MR thin-film magnetic head 113f of the magnetic head H1 reads the recording information stored along the track R4, and the MR thin-film magnetic head 113h of the magnetic head H100D reads the recording information stored along the track L4. However, in the second rotation of the rotating drum 150a, the MR thin-film magnetic head 113a of the magnetic head H100A reads the recording information stored along the track R3 whose recording information has been read in the first rotation, the MR thin-film magnetic head 113c of the magnetic head H100B reads the recording information stored along the track L3 whose recording information has been read in the first rotation, the MR thin-film magnetic head 113e of the magnetic head H100C reads the recording information stored along the track R4 whose recording information has been read in the first rotation, and the MR thin-film magnetic head 113g of the magnetic head H100D reads the information stored along the track L4 whose recording information has been read in the first rotation.

Although not shown in FIG. 11, in the third rotation of the rotating drum 150a, the MR thin-film magnetic head 113a of the magnetic head H100A re-reads the recording information stored along the track R5 whose recording information has been read in the second rotation, the MR thin-film magnetic head 113c of the magnetic head H100B re-reads the recording information stored along the track L5 whose recording information has been read in the second rotation, the MR thin-film magnetic head 113e of the magnetic head H100C rereads the recording information stored along the track R6 whose recording information has been read in the second rotation, and the MR thin-film magnetic head 113g of the magnetic head H100D re-reads the recording information stored along the track L6 whose recording information has been read in the second rotation. At this time, the MR thin-film magnetic head 113b of the magnetic head H100A reads the recording information stored along the track R7 whose recording information has not been read yet, the MR thin-film magnetic head 113d of the thin-film magnetic head H100B reads the recording information stored along the track L7 whose recording information has not been read yet, the MR thin-film magnetic head 113f of the magnetic head H100C reads the recording information stored along the track R8 whose recording information has not been read yet, and the MR thin-film magnetic head 113h of the magnetic head H100D reads the recording information stored along the track L8 whose recording information has not been read yet.

Therefore, in the magnetic recording/reproducing apparatus in which the rotating head device 150 is installed, since the efficiency with which the information recorded along the recording tracks of the magnetic tape T cannot be increased, the transfer rate of the magnetic tape T cannot be virtually increased.

However, in the magnetic recording/reproducing apparatus in which the rotating head device 150 is installed, at an early stage, that is, in the second rotation of the rotating drum 150a from the start of rotation thereof, a second reading of the recording information stored along the recording tracks is started. Therefore, even if a reading failure occurs, it is possible to omit the task of re-reading the recording information from an early stage.

A recording signal processor (not shown), which is disposed in the magnetic recording/reproducing apparatus, makes a detection as to whether or not the MR thin-film magnetic heads 113a and 113b, the MR thin-film magnetic heads 113c and 113d, the MR thin-film magnetic heads 113e and 113f, and the MR thin-film magnetic heads 113g and 113h have failed to read the pieces of recording information. If it makes a detection that a reading failure has occurred, the recording signal processor transmits a signal indicating the occurrence of the reading failure to a controller (not shown). The controller controls a motor (not shown) for rotationally driving the rotating drum 150a and the rotation of the capstan, and rewinds the magnetic tape in order to re-read the recording signals.

One image plane between vertical synchronizing signals is formed by the frame F1 and the frame F2 on the magnetic tape T on which the recording information is recorded. Therefore, the order in which the recording information is read does not correspond to the order in which the recording information is reproduced. However, as shown in FIG. 9, the pieces of recording information read by the magnetic heads H100A, H100B, H100C, and H100D are stored in a buffer memory, errors are corrected, and the pieces of recording information are re-arranged in the order in which they are reproduced. Then, the read pieces of recording information are output.

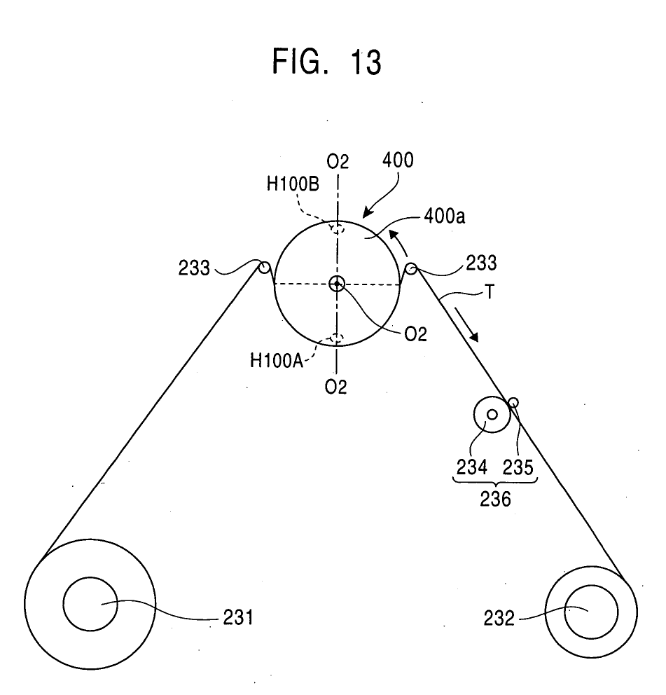

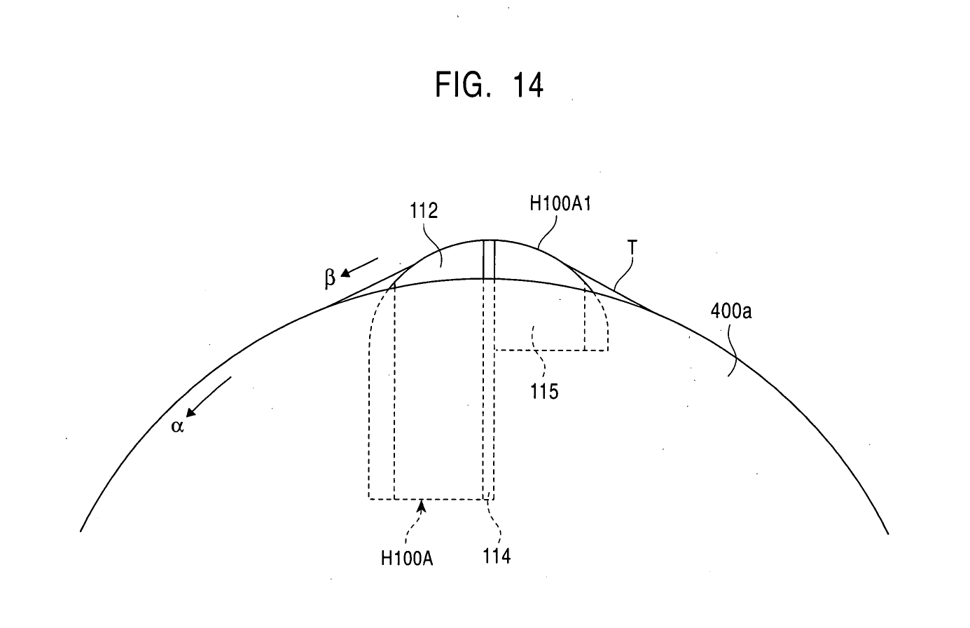

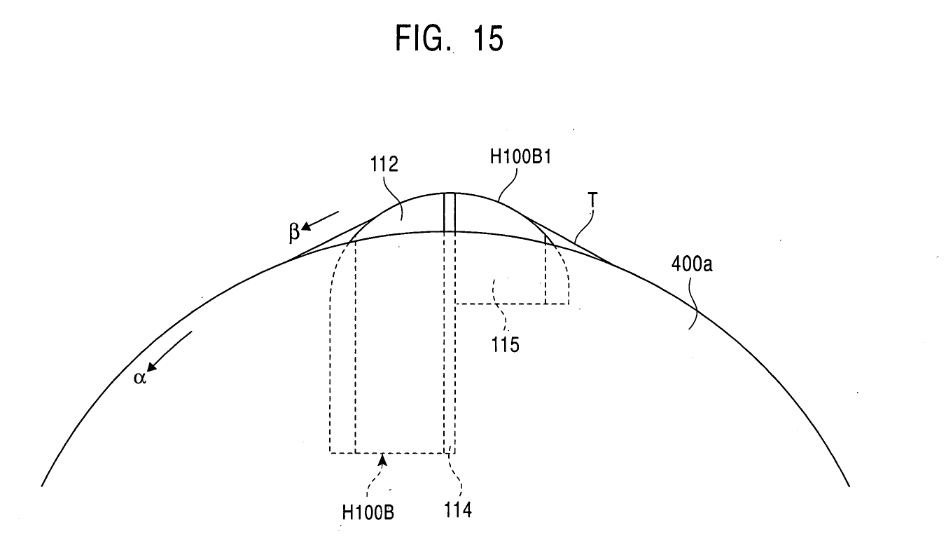

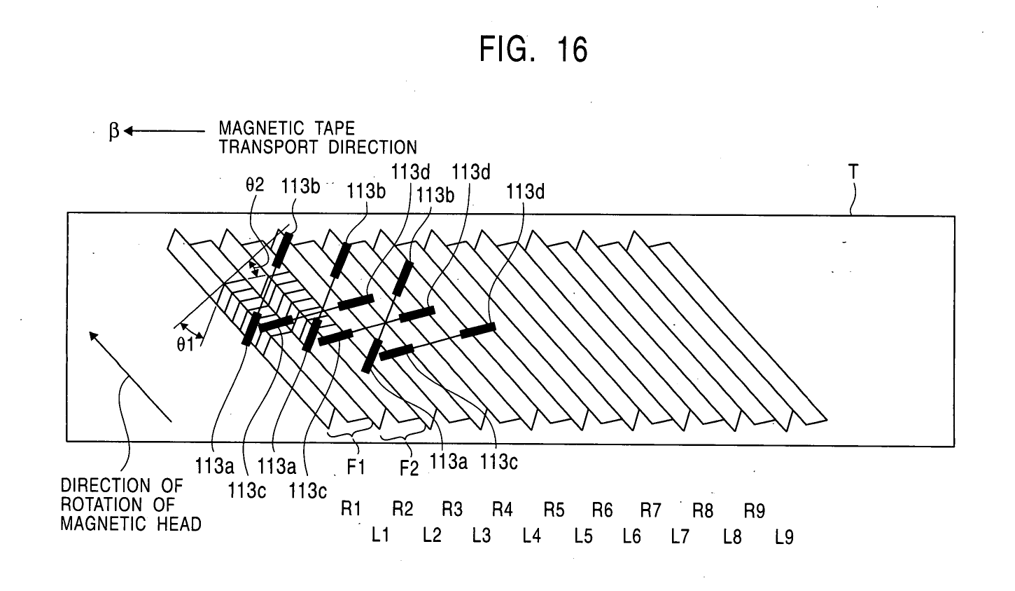

FIG. 13 is a plan view of a rotating head device of a second embodiment of the present invention that is installed in a magnetic recording/reproducing apparatus, with magnetic heads being installed. FIGS. 14 and 15 are partial enlarged views of a state in which a magnetic tape is in contact with the rotating head device shown in FIG. 13. FIG. 16 is a plan view showing the relationship between a recording surface of the magnetic tape and scanning by the magnetic heads as seen from the magnetic heads.

A rotating head device 400, which is shown in FIG. 13, is installed in, for example, a magnetic recording/reproducing apparatus of a video system or a magnetic recording/reproducing apparatus for storing computer data.

Of the structural parts of the rotating head device 400, the structural parts that correspond to those of the rotating head device 100 shown in FIG. 1 are given the same reference numerals, and will not be described in detail below.

In the rotating head device 400 shown in FIG. 13, a stationary drum (not shown) is fixed, and a rotating drum 400a, which is formed coaxially with the stationary drum, is rotatably supported at the stationary drum. By motor power, the rotating drum 400a is rotationally driven in a direction of an arrow marked beside the rotating drum 400a. A magnetic tape T, which is a recording medium, is wound upon the rotating head device 400 at a predetermined angle in a helical path, and is transported in a direction of an arrow marked beside the magnetic tape T. During this time, the rotating drum 400a rotates, and magnetic heads H100A and H100B, which are mounted to the rotating drum 400a, scan the magnetic tape T. The magnetic heads H100A and H100B have the same structures as those mounted to the rotating drum 10a shown in FIG. 1.

As shown in FIG. 13, in the rotating head device 400, two reproduction magnetic heads H100A and H100B are disposed on a central line 02-02 passing through a central point 02 of the rotating drum 400a at opposite sides.

It is desirable that the magnetic tape T be wound upon the rotating drum 400a at a winding angle that is equal to or less than 180 degrees. When the magnetic tape T is wound upon the rotating drum 400a at this winding angle, reading of recording information by the magnetic head composite H100A and reading of recording information by the magnetic head composite H100B are not carried out at the same time, so that what is called crosstalk can be prevented from occurring.

With the magnetic head H100A being mounted to the rotating drum 400a, the magnetic head H100A is in contact with the magnetic tape T as shown in FIG. 14. Here, as shown in FIG. 14, a direction a corresponds to a direction of rotation of the rotating drum 400a, and a direction β corresponds to a vertical direction, which is a direction of sliding of the magnetic tape T.

Similarly, with the magnetic head H100B being mounted to the rotating drum 400a, the magnetic head H100B is in contact with the magnetic tape T as shown in FIG. 15. Here, as shown in FIG. 15, a direction a corresponds to the direction of rotation of the rotating drum 400a, and a direction β corresponds to the vertical direction, which is the direction of sliding of the magnetic tape T.

As shown in FIG. 16, in the rotating head device 400, when the magnetic head H100A scans the magnetic tape T having tracks R (R1, R2, R3, etc.) and tracks L (L1, L2, L3, etc.) formed thereon, MR thin-film magnetic heads 113a and 113b of the magnetic head H100A scan tracks R and read recording signals. On the other hand, when the magnetic head H100B scans the magnetic tape T, MR thin-film magnetic heads 113c and 113d of the magnetic head H100B scan tracks L and read recording signals.

Hereunder, the relationship between the rotation of the rotating head device 400 and the scanning of the recording tracks of the recording tape T will be described.

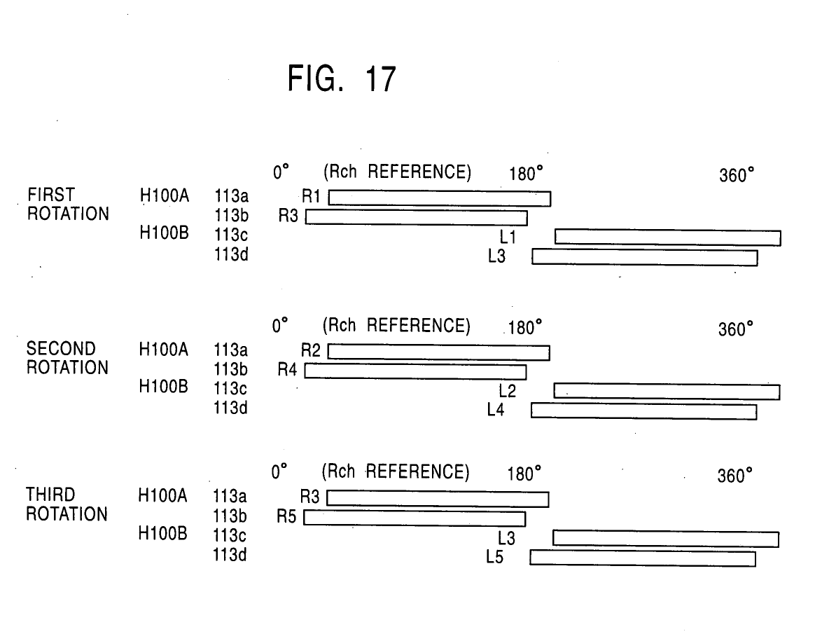

FIG. 17 shows the relationship between the rotation of the rotating drum 400a and the scanning of the recording tracks by the MR thin-film magnetic heads 113a and 113b of the magnetic head H100A, and the MR thin-film magnetic heads 113c and 113d of the magnetic head H100B.

As shown in FIGS. 16 and 17, in a first rotation of the rotating drum 400a in a range of angles of from 0 to 180 degrees, first, the magnetic head H100A comes into contact with and slides along the magnetic tape T. Here, first, the MR thin-film magnetic head 113b scans the recording track R3 of the magnetic tape T, and the MR thin-film magnetic head 113a scans the recording track R1 of the magnetic tape T in order to read recording information.

Next, when the rotating drum 400a is rotated from 180 to 360 degrees, the magnetic head H100B comes into contact with and slides along the magnetic tape T, and scans recording tracks. Here, the magnetic heads H100A and H100B are disposed on the rotating drum 400a so that the MR thin-film magnetic heads 113c and 113d of the magnetic head H100B scan recording tracks that are adjacent to the recording tracks that have been scanned by the MR thin-film magnetic heads 113a and 113b of the magnetic head H100A. From the start of the scanning of the recording tracks by the magnetic head H100A to the time the magnetic head H100B starts scanning the recording tracks, the magnetic tape T is transported by an amount corresponding to one track.

In other words, when the rotating drum 400a is rotated from 180 to 360 degrees, the magnetic head H100B comes into contact with and slides along the magnetic tape T. Here, first, the MR thin-film magnetic head 113d scans the recording track L3 of the magnetic tape T, and the MR thin-film magnetic head 113c scans the recording track L1 of the magnetic tape T in order to read recording information.

Next, the rotating drum 400a starts to rotate for the second time. Here, from the start of the scanning of the recording tracks by the magnetic head H100B to the time the magnetic head H100A starts scanning the recording tracks, the magnetic tape T is transported by an amount corresponding to two tracks.

As shown in FIGS. 16 and 17, in the second rotation of the rotating drum 400a in the range of angles of from 0 to 180 degrees, first, the magnetic head H100A comes into contact with and slides along the magnetic tape T. Here, first, the MR thin-film magnetic head 113b scans the recording track R4 of the magnetic tape T, and the MR thin-film magnetic head 113a scans the recording track R2 of the magnetic tape T in order to read recording information.

Next, when the rotating drum 400a is rotated from 180 to 360 degrees, the magnetic head H100B comes into contact with and slides along the magnetic tape T again. The MR thin-film magnetic heads 113c and 113d of the magnetic head H100B scan recording tracks that are adjacent to the recording tracks that have been scanned by the MR thin-film magnetic heads 113a and 113b of the magnetic head H100A. From the start of the scanning of the recording tracks by the magnetic head H100A to the time the magnetic head composite H100B starts scanning the recording tracks, the magnetic tape T is transported by an amount corresponding to one track.

In other words, when the rotating drum 400a is rotated from 180 to 360 degrees, the magnetic head H100B comes into contact with and slides along the magnetic tape T. Here, first, the MR thin-film magnetic head 113d scans the recording track L4 of the magnetic tape T, and the MR thin-film magnetic head 113c scans the recording track L2 of the magnetic tape T in order to read recording information.

Next, the rotating drum 400a starts to rotate for the third time. Here, from the start of the scanning of the recording tracks by the magnetic head H100B to the time the magnetic head H100A starts scanning the recording tracks, the magnetic tape T is transported by an amount corresponding to one track.

As shown in FIGS. 16 and 17, in the third rotation of the rotating drum 400a in the range of angles of from 0 to 180 degrees, first, the magnetic head H100A comes into contact with and slides along the magnetic tape T. Here, first, the MR thin-film magnetic head 113b scans the recording track R5 of the magnetic tape T, and the MR thin-film magnetic head 113a scans the recording track R3 of the magnetic tape T in order to read recording information.

Next, when the rotating drum 400a is rotated from 180 to 360 degrees, the magnetic head H100B comes into contact with and slides along the magnetic tape T. The MR thin-film magnetic heads 113c and 113d of the magnetic head H100B scan recording tracks that are adjacent to the recording tracks that have been scanned by the MR thin-film magnetic heads 113a and 113b of the magnetic head H100A. From the start of the scanning of the recording tracks by the magnetic head H100A to the time the magnetic head H100B starts scanning the recording tracks, the magnetic tape T is transported by an amount corresponding to one track.

In other words, when the rotating drum 400a is rotated from 180 to 360 degrees, the magnetic head H100B comes into contact with and slides along the magnetic tape T. The MR thin-film magnetic head 113d scans the recording track L5 of the magnetic tape T, and the MR thin-film magnetic head 113c scans the recording track L3 of the magnetic tape T in order to read recording information.

In this way, the rotating drum 400a subsequently rotates continuously in order to read recording information.

Accordingly, since the magnetic heads H100A and H100B each comprise two MR thin-film magnetic heads, it is not necessary to increase the number of magnetic heads that are mounted to the rotating drum 400a in order to increase transfer rate, so that costs are reduced. Even if the recording density is increased in recent years, it is not necessary to increase the number of magnetic heads in the rotating head device 400, so that it is easy to adjust the scanning positions of the MR thin-film magnetic heads 113a, 113b, 113c, and 113d to the positions of the recording tracks.

Here, in the first scanning, for example, the MR thin-film magnetic heads 113a and 113b of the magnetic head H100A read at the same time the recording information stored along the recording tracks R1 and R3, but do not read the recording information stored along the recording track R2. In the second scanning, the MR thin-film magnetic heads 113a and 113b read at the same time the recording information stored along the recording tracks R2 and R4, but do not read the recording information stored along the recording track R3. In the third scanning, the MR thin-film magnetic heads 113a and 113b read at the same time the recording information stored along the recording tracks R3 and R5, but do not read the recording information stored along the recording track R4.

Similarly, in the first scanning, the MR thin-film magnetic heads 113c and 113d of the magnetic head H100B read at the same time the recording information stored along the recording tracks L1 and L3, but do not read the recording information stored along the recording track L2. In the second scanning, the MR thin-film magnetic heads 113c and 113d read at the same time the recording information stored along the recording tracks L2 and L4, but do not read the recording information stored along the recording track L3. In the third scanning, the MR thin-film magnetic heads 113c and 113d read at the same time the recording information stored along the recording tracks L3 and L5, but do not read the recording information stored along the recording track L4.

Accordingly, in the magnetic recording/reproducing apparatus in which the rotating head device 400 is installed, recording tracks having one track disposed therebetween among the plurality of recording tracks formed at the same azimuth angle are scanned at the same time to read the recording information. By virtue of such a structure, the MR thin-film magnetic heads 113a and 113b of the magnetic head H100A, and the MR thin-film magnetic heads 113c and 113d of the magnetic head H100B can be formed with large intervals therebetween in the longitudinal direction. Therefore, even if tracks are narrowed due to increasing recording density, it is possible to dispose structural portions, such as hard bias layers, at respective end portions of the MR thin-film magnetic heads 113a and 113b, and the MR thin-film magnetic heads 113c and 113d.

In the magnetic recording/reproducing apparatus in which the rotating head device 400 is installed, each time the rotating drum 400a rotates once, the recording information stored along a total of four tracks (two recording tracks formed at the azimuth angle formed by a line inclined in one direction, and two recording tracks formed at the azimuth angle formed by a line inclined in the other direction) can be read. However, in the magnetic recording/reproducing apparatus in which the rotating head device 400 is installed, from the third rotation onwards, the recording information stored along the tracks R and L whose recording information has been read is re-read by the MR thin-film magnetic heads 113a and 113c.

In the aforementioned example, in the first rotation of the rotating drum 400a, the MR thin-film magnetic head 113b of the magnetic head H100A reads the recording information stored along the track R3, and the MR thin-film magnetic head 113d of the magnetic head H100B reads the recording information stored along the track L3. However, in the third rotation of the rotating drum 400a, the MR thin-film magnetic head 113a of the magnetic head H100A reads the recording information stored along the track R3 whose recording information has been read in the first rotation, and the MR thin-film magnetic head 113c of the magnetic head H100B reads the recording information stored along the track L3 whose recording information has been read in the first rotation. Although not shown in FIG. 16, in the fourth rotation of the rotating drum 400a, the MR thin-film magnetic head 113a of the magnetic head H100A re-reads the recording information stored along the track R4 whose recording information has been read in the second rotation, and the MR thin-film magnetic head 113c of the magnetic head H100B re-reads the recording information stored along the track L4 whose recording information has been read in the second rotation. At this time, the MR thin-film magnetic head 113b of the magnetic head H100A reads the recording information stored along the track R6 whose recording information has not been read yet, and the MR thin-film magnetic head 113d of the magnetic head H100B reads the recording information stored along the track L6 whose recording information has not been read yet.

Therefore, in the magnetic recording/reproducing apparatus in which the rotating head device 400 is installed, since the efficiency with which the information recorded along the recording tracks of the magnetic tape T cannot be increased, the transfer rate of the magnetic tape T cannot be virtually increased.

However, in the magnetic recording/reproducing apparatus in which the rotating head device 400 is installed, by reading recording tracks twice from the third rotation onwards, the task of re-reading recording information on the recording medium can be omitted even if a reading failure occurs. In the rotating head device 400, two magnetic heads H100A and H100B are mounted to the rotating drum 400a. Therefore, fewer magnetic heads are mounted to the rotating drum 400a than to the rotating drum 150a of the rotating head device 150 shown in FIG. 10. Consequently, by constructing the rotating head device 400 in this way, the rotating head device makes it possible to omit the task of re-reading recording information on the recording medium and can be easily manufactured at a low cost.

One image plane between vertical synchronizing signals is formed by a frame F1 and a frame F2 on the magnetic tape T on which the recording information is recorded. Therefore, the order in which the recording information is read does not correspond to the order in which the recording information is reproduced. However, as shown in FIG. 15, the pieces of recording information read by the magnetic heads H100A and H100B are stored in a buffer memory, errors are corrected, and the pieces of recording information are re-arranged in the order in which they are reproduced. Then, the read pieces of recording information are output.

Accordingly, although, in the rotating head device of the present invention, two recording tracks having one track disposed therebetween among the plurality of recording tracks formed at an azimuth angle formed by a line inclined in the same direction are scanned at the same time by one magnetic head to read recording information, the present invention is not limited thereto. Therefore, two recording tracks having two or more other recording tracks disposed therebetween among the plurality of recording tracks formed at an azimuth angle formed by a line inclined in the same direction may be scanned at the same time by one magnetic head to read recording information. By virtue of such a structure, the MR thin-film magnetic heads of one magnetic head can be formed with even large intervals therebetween in the longitudinal direction. Therefore, even if tracks are narrowed, it is possible to dispose structural portions, such as hard bias layers, at respective end portions of the magnetic reproducing elements.

The number of recording tracks that one magnetic head scans at the same time is not limited to two. One magnetic head may have three or more magnetic reproducing elements, which scan at the same time three or more recording tracks in order to read recording information. By virtue of such a structure, since it is possible to further increase the transfer rate of the recording medium, the number of magnetic heads that are installed in the rotating head can be further reduced. Therefore, it is possible to effectively reduce costs, and to more easily adjust the scanning positions of the magnetic reproducing elements to the positions of recording tracks.

Accordingly, two or more magnetic reproducing elements of the magnetic head installed in the rotating head device of the present invention scan at the same time a plurality of recording tracks whose recording information is recorded at an azimuth angle formed by a line that inclines in the same direction in order to read the recording information. Therefore, the recording information stored along recording tracks can be read by one scanning operation of one magnetic head, so that it is possible to increase the transfer rate of the recording medium. In addition, it is not necessary to mount many magnetic heads to the rotating drum to increase the transfer rate, so that costs can be reduced. Since it is not necessary to increase the number of magnetic heads that are installed, it is easy to adjust the scanning positions of the magnetic reproducing elements to the positions of the recording tracks.

The magnetic reproducing elements of one magnetic head can be formed with even larger intervals therebetween in the longitudinal direction. Therefore, even if tracks are narrowed, it is possible to dispose structural portions, such as hard bias layers, at respective end portions of the magnetic reproducing elements.

In a magnetic head in which one of the magnetic reproducing elements scans a recording track that has already been scanned, when a reading failure occurs, the task of re-reading the recording information is not required.

What is claimed is:

1. A rotating head device comprising:
a rotating drum whose outer peripheral surface is a sliding surface that slides on a recording medium; and
a plurality of magnetic heads, a first magnetic head and a second magnetic head, disposed at the sliding surface of the rotating drum,
wherein the first magnetic head and the second magnetic head are mounted to the rotating drum, the first magnetic head comprising at least two magnetic reproducing elements disposed at a first azimuth angle with respect to a direction of sliding on the recording medium, the second magnetic head comprising at least two magnetic reproducing elements disposed at a second azimuth angle with respect to the direction of sliding on the recording medium, the second azimuth angle being formed by a line that inclines in a direction opposite to a direction in which a line that forms the first azimuth angle inclines, and
wherein the first magnetic head and the second magnetic head are positioned, so that, when the rotating drum rotates, the magnetic reproducing elements of the first magnetic head scan at the same time recording tracks formed by recording signals at the same first azimuth angle, with an odd number of at least three recording tracks being disposed between the recording tracks that are scanned by the first magnetic head, and the magnetic reproducing elements of the second magnetic head scan at the same time recording tracks formed by recording signals at the second azimuth angle that is different from the first azimuth angle, with an odd number of at least three recording tracks being disposed between the recording tracks that are scanned by the second magnetic head.

2. A rotating head device according to claim 1, wherein, after the magnetic reproducing elements of the first magnetic head have scanned the recording tracks, the magnetic reproducing elements of the second magnetic head scan recording tracks that are adjacent to the recording tracks that have been scanned by the magnetic reproducing elements of the first magnetic head.

3. A rotating head device according to claim 1, wherein the first magnetic head and the second magnetic head are disposed close to each other at the rotating drum.

4. A rotating head device according to claim 2, wherein the first magnetic head and the second magnetic head are disposed close to each other at the rotating drum.

5. A rotating head device according to claim 3, wherein the first magnetic head and the second magnetic head that are disposed close to each other are defined as a set, and wherein two of the sets, a first set and a second set, are disposed at the rotating drum at an angle of 90 degrees from each other in a direction of rotation thereof.

6. A rotating head device according to claim 4, wherein the first magnetic head and the second magnetic head that are disposed close to each other are defined as a set, and wherein two of the sets, a first set and a second set, are disposed at the rotating drum at an angle of 90 degrees from each other in a direction of rotation thereof.

7. A rotating head device according to claim 3, wherein the first magnetic head and the second magnetic head that are disposed close to each other are defined as a set, and wherein two of the sets, a first set and a second set, are disposed at the rotating drum at an angle of 180 degrees from each other.

8. A rotating head device according to claim 1, wherein the first and second magnetic heads are disposed at the rotating drum at an angle of 180 degrees from each other.

9. A rotating head device according to claim 4, wherein the first magnetic head and the second magnetic head that are disposed close to each other are defined as a set, and wherein two of the sets, a first set and a second set, are disposed at the rotating drum at an angle of 180 degrees from each other.

10. A rotating head device according to claim 2, wherein the first and second magnetic heads are disposed at the rotating drum at an angle of 180 degrees from each other.

11. A magnetic recording/reproducing apparatus comprising:
a rotating head device comprising a rotating drum whose outer peripheral surface is a sliding surface that slides on a recording medium; and a plurality of magnetic heads, a first magnetic head and a second magnetic head, disposed at the sliding surface of the rotating drum; and
magnetic tape feeding means for transporting a magnetic tape as a result of bringing the magnetic tape within a predetermined angle range of the sliding surface of the rotating drum,
wherein the first magnetic head and the second magnetic head are mounted to the rotating drum, the first magnetic head comprising at least two magnetic reproducing elements disposed at a first azimuth angle with respect to a direction of sliding on the recording medium, the second magnetic head comprising at least two magnetic reproducing elements disposed at a second azimuth angle with respect to the direction of sliding on the recording medium, the second azimuth angle being formed by a line that inclines in a direction opposite to a direction in which a line that forms the first azimuth angle inclines, and
wherein the first magnetic head and the second magnetic head are positioned, so that, when the rotating drum rotates, the magnetic reproducing elements of the first magnetic head scan at the same time recording tracks formed by recording signals at the same first azimuth angle, with an odd number of at least three recording tracks being disposed between the recording tracks that are scanned by the first magnetic head, and the magnetic reproducing elements of the second magnetic head scan at the same time recording tracks formed by recording signals at the second azimuth angle that is different from the first azimuth angle, with an odd number of at least three recording tracks being disposed between the recording tracks that are scanned by the second magnetic head.

12. A magnetic recording/reproducing apparatus according to claim 11, wherein, after the magnetic reproducing elements of the first magnetic head have scanned the recording tracks, the magnetic reproducing elements of the second magnetic head scan recording tracks that are adjacent to the recording tracks that have been scanned by the magnetic reproducing elements of the first magnetic head.

13. A magnetic recording/reproducing apparatus according to claim 11, wherein the first magnetic head and the second magnetic head are disposed close to each other at the rotating drum.

14. A magnetic recording/reproducing apparatus according to claim 12, wherein the first magnetic head and the second magnetic head are disposed close to each other at the rotating drum.

15. A magnetic recording/reproducing apparatus according to claim 13, wherein the first magnetic head and the second magnetic head that are disposed close to each other are defined as a set, and wherein two of the sets, a first set and a second set, are disposed at the rotating drum at an angle of 90 degrees from each other in a direction of rotation thereof.

16. A magnetic recording/reproducing apparatus according to claim 14, wherein the first magnetic head and the second magnetic head that are disposed close to each other are defined as a set, and wherein two of the sets, a first set and a second set, are disposed at the rotating drum at an angle of 90 degrees from each other in a direction of rotation thereof.

17. A magnetic recording/reproducing apparatus according to claim 13, wherein the first magnetic head and the second magnetic head that are disposed close to each other are defined as a set, and wherein two of the sets, a first set and a second set, are disposed at the rotating drum at an angle of 180 degrees from each other.

18. A magnetic recording/reproducing apparatus according to claim 11, wherein the first and second magnetic heads are disposed at the rotating drum at an angle of 180 degrees from each other.

19. A magnetic recording/reproducing apparatus according to claim 14, wherein the first magnetic head and the second magnetic head that are disposed close to each other are defined as a set, and wherein two of the sets, a first set and a second set, are disposed at the rotating drum at an angle of 180 degrees from each other.

20. A magnetic recording/reproducing apparatus according to claim 12, wherein the first and second magnetic heads are disposed at the rotating drum at an angle of 180 degrees from each other.

21. A magnetic recording/reproducing apparatus according to claim 11, wherein a recording track of the magnetic tape is not scanned again by a different magnetic reproducing element.

22. A magnetic recording/reproducing apparatus according to claim 11, wherein a recording track of the magnetic tape is scanned again by a different magnetic reproducing element.

23. A magnetic recording/reproducing apparatus according to claim 15, wherein a recording track of the magnetic tape is not scanned again by a different magnetic reproducing element.

24. A magnetic recording/reproducing apparatus according to claim 23, wherein, after the first magnetic head of the first set has scanned the magnetic tape, the magnetic tape is transported by an amount corresponding to two tracks by the time the first magnetic head of the second set scans the magnetic tape, and, wherein, after the first magnetic head of the second set has scanned the magnetic tape, the magnetic tape is transported by an amount corresponding to six tracks by the time the first magnetic head of the first set scans the magnetic tape.

25. A magnetic recording/reproducing apparatus according to claim 17, wherein a recording track of the magnetic tape is scanned again by a different magnetic reproducing element.

26. A magnetic recording/reproducing apparatus according to claim 25, wherein from the time the first magnetic head of the first set scans the magnetic tape to the time the first magnetic head of the second set scans the magnetic tape, the magnetic tape is transported by an amount corresponding to two tracks.

27. A magnetic recording/reproducing apparatus according to claim 16, wherein a recording track of the magnetic tape is not scanned again by a different magnetic reproducing element.

28. A magnetic recording/reproducing apparatus according to claim 27, wherein, after the first magnetic head of the first set has scanned the magnetic tape, the magnetic tape is transported by an amount corresponding to two tracks by the time the first magnetic head of the second set scans the magnetic tape, and, wherein, after the first magnetic head of the second set has scanned the magnetic tape, the magnetic tape is transported by an amount corresponding to six tracks by the time the first magnetic head of the first set scans the magnetic tape.

29. A magnetic recording/reproducing apparatus according to claim 19, wherein a recording track of the magnetic tape is scanned again by a different magnetic reproducing element.

30. A magnetic recording/reproducing apparatus according to claim 29, wherein from the time the first magnetic head of the first set scans the magnetic tape to the time the first magnetic head of the second set scans the magnetic tape, the magnetic tape is transported by an amount corresponding to two tracks.

31. A magnetic recording/reproducing apparatus according to claim 13, wherein a recording track of the magnetic tape is not scanned again by a different magnetic reproducing element.

32. A magnetic recording/reproducing apparatus according to claim 13, wherein a recording track of the magnetic tape is scanned again by a different magnetic reproducing element.

33. A magnetic recording/reproducing apparatus according to claim 18, wherein a recording track of the magnetic tape is scanned again by a different magnetic reproducing element.

34. A magnetic recording/reproducing apparatus according to claim 33, wherein from the time the first magnetic head scans the magnetic tape to the time the second magnetic head scans the magnetic tape, the magnetic tape is transported by an amount corresponding to one track.
